(19) United States
(12) Patent Application Publication
(10) Pub. No.: US 2025/0341998 A1
(43) Pub. Date: Nov. 6, 2025

(54) DISPLAY SWITCHING SYSTEM AND TABLET DRIVER PROGRAM

(71) Applicant: Wacom Co., Ltd., Saitama (JP)

(72) Inventors: Ai NAKAIGAWA, Saitama (JP); Tatsunori KATO, Saitama (JP)

(73) Assignee: Wacom Co., Ltd., Saitama (JP)

(21) Appl. No.: 19/273,456

(22) Filed: Jul. 18, 2025

Related U.S. Application Data
(63) Continuation of application No. PCT/JP2024/000139, filed on Jan. 9, 2024.

(30) Foreign Application Priority Data
Jan. 20, 2023 (JP) 2023-007366

(51) Int. Cl. G06F 3/14; G06F 3/041; G06F 3/04883; G09G 3/20

(52) U.S. Cl. CPC G06F 3/1431; G06F 3/04162; G06F 3/04883; G09G 3/2096; G09G 2340/0464; G09G 2354/00; G09G 2360/04; G09G 2370/06

(57) ABSTRACT

A display switching system is provided to support using, through an input apparatus such as a tablet apparatus, a plurality of displays connected to an information processing apparatus. The input apparatus indicates a position on one of the plurality of displays. The information processing apparatus includes an association unit which associates an input area of the input apparatus with a display area of one of the plurality of displays; a determination unit which determines whether an input from the input apparatus is a position indication input or a change instruction input; and a changing unit which changes an association between the input apparatus and one of the plurality of displays based on the change instruction input. When the input from the input apparatus is the change instruction input, the changing unit changes the association between the input apparatus and one of the plurality of displays.

### BACKGROUND

### Technical Field

This disclosure relates to a system and a program that make it possible to use two or more displays connected to an information processing apparatus, such as a personal computer (PC), through a tablet apparatus connected to the information processing apparatus.

### Description of the Related Art

In a meeting or in a class, for example, so-called multi-displays are used in which a plurality of displays are vertically or horizontally arranged with information displayed on each display. There are inventions directed to improving the functionality of such multi-displays. For example, Japanese Patent Laid-Open No. 2009-198734 (hereinafter, referred to as Patent Document 1) describes a control method, a control program, and a control apparatus of multi-displays, with which the presenter need not move around too much, and the presenter can easily and intuitively switch the screen display to another display apparatus or edit the displayed data. The invention disclosed in Patent Document 1 provides a multi-display system including one master display apparatus including a touch panel and a display unit, one or more slave display apparatuses each including a display unit, and a control apparatus that controls these master and slave display apparatuses.

When, for example, a gesture operation is performed through the touch panel of the master display apparatus, the control apparatus captures the content displayed on the display unit of the master display apparatus according to the operation, and displays the content on the display units of the slave display apparatuses. The control apparatus can also add characters or a drawing to the content displayed on the display unit of the master display apparatus, according to the operation performed through the touch panel of the master display apparatus. The displayed content of the display unit of the master display apparatus can be cleared, and other information can be input through the touch panel to display the other information on the display unit of the master display apparatus. However, the content displayed on the display units of the slave display apparatuses is a captured still image, and the image cannot be edited.

In recent years, a multi-display function is supported by a PC used by an individual at work, for example. The multi-display function is realized by connecting a plurality of displays to a PC for the purpose of enlarging the display area. For example, three displays arranged close to each other in a horizontal row on a desk are connected to a PC to realize the multi-display function. In this case, a large memory area corresponding to the display areas (screen areas) of the three displays is reserved in the PC, and the memory area is mapped for (associated with) each display.

Therefore, an operation is possible, such as launching a browser through the display on the left to perform a search, launching a drawing application through the display at the center to input a drawing, and launching a photo application through the display on the right to display a photograph. That is, different processes can concurrently be executed through three displays. In using the multi-display function, it can also be assumed that one large display is formed of the three displays, and an image drawn through the display at the center can be displayed on a display screen of the one large display, for example.

Typically, a so-called computer mouse is connected as a pointing device to the PC. The mouse allows a user to perform a position indication operation in a large area range (an infinite range in theory) according to the amount of movement on the desk. Therefore, the mouse can be used to move a cursor to a position of an intended display (or its coordinate position in its corresponding memory area) to change the target display, regardless of the location of the current target display. As a result, when, for example, the user uses the display at the center to input a drawing, while maintaining the state of the drawing process, the user can easily perform an operation of moving the cursor to the display on the left to open a browser to perform a search. In addition, an image drawn on the display at the center can be enlarged to display the drawing image on one large display including the three displays.

However, when a tablet apparatus is used as an input device, changing the target display is harder than when the mouse is used. An operation surface of the tablet apparatus typically corresponds to the display screen of a display, and a position on the display screen of the display other than the target display cannot be designated by an operation on the operation surface of the tablet apparatus. In one aspect, it may be possible to configure the operation surface of the tablet apparatus to correspond to a large display including the display screens of a plurality of connected displays. In this case, the operation surface of the tablet apparatus is mapped to a large memory area corresponding to the display screen of the large display, and any position on the large display screen including the plurality of displays can be indicated.

However, each operation area corresponding to one of the individual displays on the operation surface of the tablet apparatus become small. This is not preferable because it may be difficult to input instructions corresponding to the individual displays. In view of this, a switch button for the target display can be provided on the tablet apparatus, and the target display can be switched every time the switch button is pressed. However, if there are three or more displays connected to the PC, the intended display cannot always be selected by one pressing operation, and the operation on the switch button may become cumbersome.

### SUMMARY OF THE INVENTION

In view of the above, an aspect of the disclosure is directed to switching displays, which are mapped to a tablet apparatus used to support or control a multi-display function, based on an intuitive operation such as a gesture operation.

To solve the problems, a display switching system is provided which supports, through an input apparatus, a plurality of displays connected to an information processing apparatus. The input apparatus is an apparatus that indicates a position on one of the plurality of displays. The information processing apparatus includes an association unit configured to associate an input area of the input apparatus with a display area of one of the plurality of displays. The information processing apparatus includes a determination unit configured to determine whether an input from the input apparatus is a position indication input or a change instruction input, and a changing unit configured to change an association between the input apparatus and the one of the plurality of displays based on the change instruction input. When the determination unit determines that the input from the input apparatus is the change instruction input, the changing unit changes the associating between the input apparatus and one of the plurality of displays according to the change instruction input.

### BRIEF DESCRIPTION OF THE DRAWINGS

FIG. 1 is a block diagram describing a configuration example of an information processing system of an embodiment with a multi-display function;

FIGS. 2A to 2C are diagrams describing examples of a gesture operation for switching a target display;

FIGS. 3A to 3C are diagrams describing examples of the gesture operation for switching the target display;

FIGS. 4A and 4B are diagrams describing examples of the gesture operation for switching the target display;

FIGS. 5A to 5F are diagrams describing an example of the gesture operation for switching the target display;

FIGS. 6A to 6C are diagrams describing an example of the gesture operation for switching an operation mode;

FIG. 7 is a block diagram describing a configuration example of a tablet apparatus of the embodiment;

FIG. 8 is a block diagram describing a configuration example of an information processing apparatus of the embodiment;

FIG. 9 is a block diagram describing a configuration example of a tablet driver apparatus of the embodiment;

FIGS. 10A to 10C are diagrams describing a mode of connecting displays to the information processing apparatus, screen memory areas reserved according to the connected displays, and management of the screen memory areas;

FIGS. 11A to 11C are diagrams describing a mode of connecting displays to the information processing apparatus, screen memory areas reserved according to the connected displays, and management of the screen memory areas;

FIGS. 12A to 12C are diagrams describing a mode of connecting displays to the information processing apparatus, screen memory areas reserved according to the connected displays, and management of the screen memory areas;

FIGS. 13A to 13C are diagrams describing a mode of connecting displays to the information processing apparatus, screen memory areas reserved according to the connected displays, and management of the screen memory areas;

FIGS. 14A to 14C are diagrams describing a mode of connecting displays to the information processing apparatus, screen memory areas reserved according to the connected displays, and management of the screen memory areas;

FIG. 15 is a flow chart describing a process executed by the tablet driver apparatus of the embodiment;

FIG. 16 is a flow chart following the flow chart of FIG. 15;

FIG. 17 is a diagram describing a case of switching a display (a target display) mapped in a tablet with a display function; and

FIG. 18 is a diagram describing a case of switching the display (a target display) mapped in the tablet with a display function.

### DETAILED DESCRIPTION

An embodiment of a system and a program according to the disclosure will be described with reference to the drawings. The system and the program described below can be used with various types of tablet apparatuses. The tablet apparatus refers to a plate-shaped electronic device which, as described in detail later, includes a sheet-shaped position detection sensor (a sensor unit) including a sensor surface having a predetermined area. An upper surface of the position detection sensor is an operation surface that receives an instruction input by a user. The tablet apparatus allows the user to write or input a character or the like, draw or input a picture, illustration, or the like, and to input an instruction relative to an icon or the like by pointing an electronic pen or the like to the operation surface to perform a pointing operation (a position indication operation).

Note that examples of the tablet apparatus include a so-called liquid crystal tablet and a so-called plate tablet (a plate-shaped tablet). The liquid crystal tablet is an input and output device including a display element (a display apparatus), such as a liquid crystal display (LCD), and a position detection sensor. The liquid crystal tablet allows the user to perform a position indication operation (position indication input), such as writing and drawing, and to display input information. The plate-shaped tablet includes a position detection sensor, but does not include a display element such as an LCD, and is used as an input device for a PC which supports a position indication operation (position indication input) such as writing and drawing. The apparatus and program of the present disclosure can be used with either a liquid crystal tablet or a plate-shaped tablet. To simplify the description, the following description is directed to an embodiment which includes a plate-shaped tablet.

### [Configuration Example of Information Processing System (Display Switching System)]

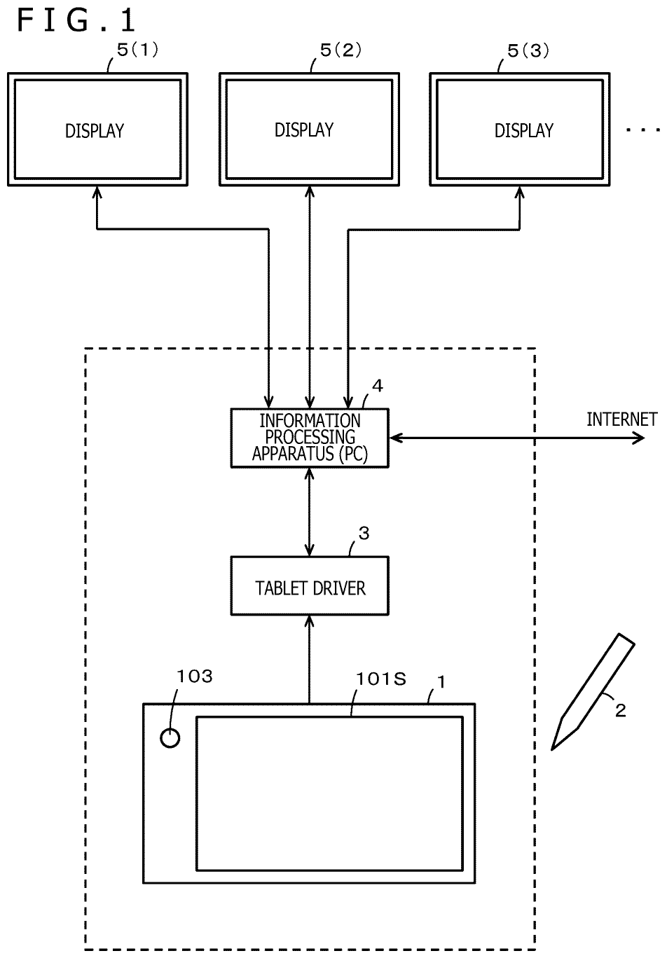

FIG. 1 is a block diagram describing a configuration example of an information processing system which supports a multi-display function. As illustrated in FIG. 1, the information processing system includes a tablet apparatus 1 as an input device and allows the user to perform a pointing operation with an electronic pen 2. The tablet apparatus 1 is a so-called plate tablet as described above, and is connected to an information processing apparatus 4 through a tablet driver 3.

The tablet driver 3 is a device driver which causes the tablet apparatus 1 to function as an input device for the information processing apparatus 4. The tablet driver 3 performs a function of preparing output data from the tablet apparatus 1 to be processable by the information processing apparatus 4 and then delivering the prepared output data to the information processing apparatus 4. The tablet driver 3 can be realized as an apparatus which is positioned between the tablet apparatus 1 and the information processing apparatus 4 (a connection apparatus), or can be realized as software executed by the information processing apparatus 4 or the tablet apparatus 1. To simplify the description, the tablet driver 3 is realized as software executed by the information processing apparatus 4 in the present embodiment.

The information processing apparatus 4 is an apparatus that executes various processes according to instruction information received from the tablet apparatus 1 and is a PC in the present embodiment. The information processing apparatus 4 has a multi-display function that makes it possible to connect and use a plurality of displays to enlarge a display area. FIG. 1 illustrates a case in which three displays 5(1), 5(2), and 5(3) are connected to the information processing apparatus 4. The information processing apparatus 4 is also connected to the Internet.

In this way, the tablet apparatus 1 can issue an instruction to the information processing apparatus 4 through the tablet driver 3, and the information processing apparatus 4 can concurrently execute different processes through the displays 5(1), 5(2), and 5(3), respectively. For example, a browser can be launched through the display 5(1) to perform an Internet search; a drawing application can be launched through the display 5(2) to draw a picture, for example; and a photo application can be launched through the display 5(3) to display a photograph. In addition, three display screens of the displays 5(1), 5(2), and 5(3) can be put together to provide one large display screen, and a drawing image can be enlarged and displayed on the large display screen.

As illustrated in FIG. 1, the tablet apparatus 1 includes an operation surface 101S that receives a pointing operation of the electronic pen 2. Although the pointing operation on the operation surface 101S is typically performed to input writing, a character, a drawing, a picture, an illustration and the like, the pointing operation can be performed to input an instruction for an icon or the like in some cases. The tablet apparatus 1 allows the user to use the electronic pen 2 to perform a gesture operation (a gesture input) also. Therefore, the tablet apparatus 1 includes an operation button 103, which is operated when the electronic pen 2 is used to perform a gesture operation through the operation surface 101S, to distinguish the gesture operation (indicative of an instruction) from a normal position indication operation (such as a writing input or a drawing input).

Although the word “gesture” typically refers to a motion of a body or hands, a gesture operation as used herein may refer to an operation of moving the electronic pen 2 in a defined manner on the operation surface 101S of the tablet apparatus 1. A gesture operation is performed on the information processing system of the present embodiment to instruct the information processing apparatus 4 to switch (change) a target display (i.e., to switch a display mapped to the tablet apparatus 1) or to switch (change) an operation mode.

A “target display” simply refers to a display mapped to/in the tablet apparatus 1, and the target display corresponds to a memory area allocated to support display processing of the display. In the present embodiment, “operation modes” include an individual mapping mode and a full mapping mode. The individual mapping mode is an operation state that allows the user to execute different processes through the different connected displays. In other words, the individual mapping mode is an operation state in which the memory areas allocated to the individual displays are used to execute the processes. The full mapping mode is an operation state that allows the user to execute a process through one large display screen by assuming that the large display screen is formed of the display screens of all connected displays. In other words, the full mapping mode is an operation state in which a large memory area allocated to one large display screen is used to execute the process.

The tablet apparatus 1, when an operation input is received through the operation surface 101S or when the operation button 103 is pressed, sequentially outputs position indication data at each predetermined timing, as will be described in detail later. In this way, the tablet driver 3 can determine which type of operation is performed on the tablet apparatus 1. Specifically, the tablet driver 3 can determine (distinguish) whether the operation is a writing or drawing input not involving a pressing operation of the operation button 103, a position indication input for selecting an icon or the like, a gesture operation involving a pressing operation of the operation button 103, or only a pressing operation of the operation button 103.

Note that the information processing system can be one apparatus, such as a tablet PC, having the functions of the tablet apparatus 1, the tablet driver 3, and the information processing apparatus 4, as indicated by a dotted line surrounding the apparatus of FIG. 1. Although FIG. 1 illustrates the case of the three displays 5(1), 5(2), and 5(3) connected to the information processing apparatus 4, the configuration is not limited to this example. More displays may be connected to the information processing apparatus 4 to support the multi-display function. That is, the information processing apparatus 4 makes it possible to support the multi-display function using any number of two or more displays.

### [Gesture Operation and Content of Instruction]

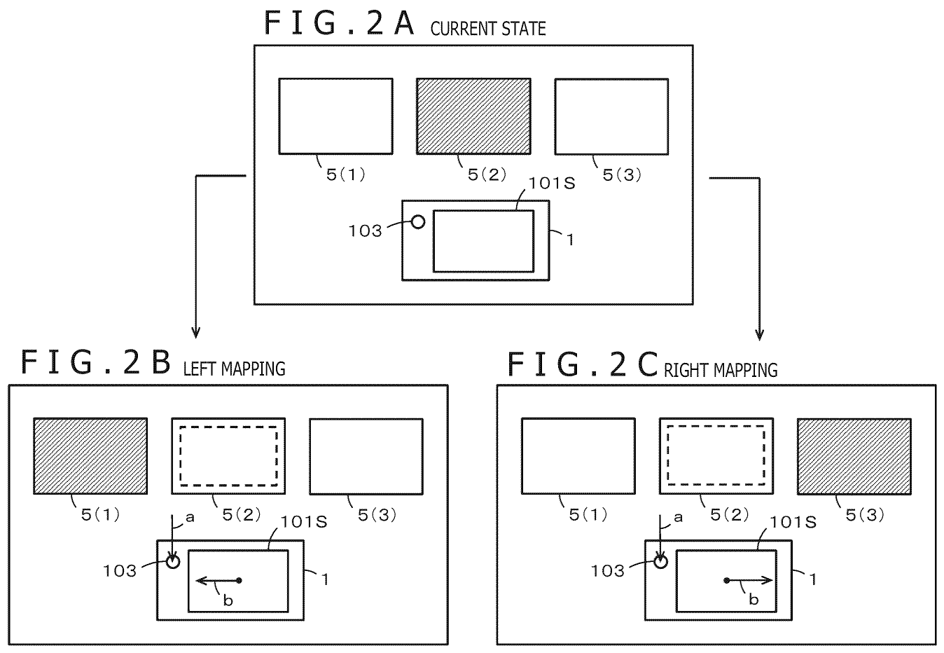

FIGS. 2A to 5F are diagrams describing examples of a gesture operation to switch the display (target display) mapped to the tablet apparatus 1. In the information processing system of the present embodiment, a plurality of displays can be connected to the information processing apparatus 4 to support the multi-display function, as described above. Therefore, the electronic pen 2 can be used to perform a gesture operation on the tablet apparatus 1 to intuitively switch the display (target display) mapped to the tablet apparatus 1 to an intended (target) display.

### <Example of Using a Single Gesture to Switch Mapped Displays>

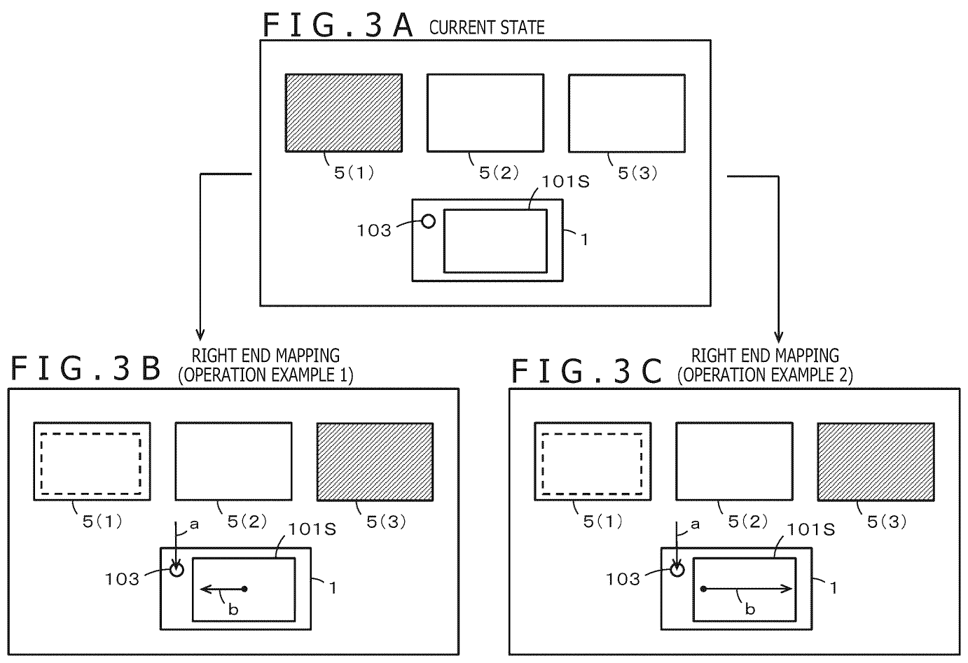

A case in which the three displays 5(1), 5(2), and 5(3) are connected to the information processing apparatus 4 will be examined, as illustrated in FIGS. 2A to 3C. It is assumed that the display 5(2) is currently the target display mapped to (in) the tablet apparatus 1, as indicated by a filled rectangle in FIG. 2A. At this time, it is assumed that a certain process needs to be executed through the display 5(1) on the left. In this case, the user brings the electronic pen 2 into contact with the operation surface 101S of the tablet apparatus 1 while pressing the operation button 103 of the tablet apparatus 1, as indicated by an arrow “a” in FIG. 2B, and the user performs an operation of moving the electronic pen 2 to the left side as indicated by an arrow “b” while the electronic pen 2 is in contact with the operation surface 101S.

Because the position indication operation is performed while the operation button 103 is pressed, the tablet driver 3 determines that the operation is a gesture operation intended to issue an instruction to switch the target display to the display on the left side. As a result, the display mapped in (associated with) the tablet apparatus 1 is switched from the display 5(2) to the display 5(1). Therefore, the information processing apparatus 4 can display the processing result through the display 5(1). That is, switching of the target display is equivalent to switching of the memory area mapped for (allocated to) each display.

As shown in FIG. 2A, it is assumed again that the display 5(2) is currently the target display mapped in the tablet apparatus 1 as indicated by the filled rectangle. At this time, it is assumed that a certain process needs to be executed through the display 5(3) on the right. In this case, as illustrated in FIG. 2C, the user brings the electronic pen 2 into contact with the operation surface 101S while pressing the operation button 103 as indicated by an arrow “a”, and the user performs an operation of moving the electronic pen 2 to the right side as indicated by an arrow “b” while the electronic pen 2 is in contact with the operation surface 101S.

Because the position indication operation is performed while the operation button 103 is pressed, the tablet driver 3 determines that the operation is a gesture operation intended to issue an instruction to switch the target display to the display on the right side. As a result, the tablet driver 3 switches the target display from the display 5(2) illustrated with a dotted line to the display 5(3) indicated by a filled rectangle as illustrated in FIG. 2C and maintains this state. That is, the display mapped in (associated with) the tablet apparatus 1 is switched from the display 5(2) to the display 5(3).

In this way, it is assumed that the target display is switched to the display 5(3) as illustrated in FIG. 2C. The tablet driver 3 converts coordinate data, which are included in the position indication data associated with a position indication operation not involving a pressing operation of the operation button 103, into coordinates in the memory area allocated to the display 5(3), and provides the coordinates to the information processing apparatus 4. In this case, the information processing apparatus 4 can use the position indication data from the tablet driver 3 “as is” to execute necessary processing. Therefore, the information processing apparatus 4 can display the processing through the display 5(3).

It is assumed that the display 5(1) on the left is currently the target display mapped in the tablet apparatus 1 as indicated by a filled rectangle in FIG. 3A. At this time, it is assumed that a certain process needs to be executed through the display 5(3) on the right. In this case, there can be two switching operations. In one operation, the user brings the electronic pen 2 into contact with the operation surface 101S while pressing the operation button 103 as indicated by an arrow “a” as illustrated in FIG. 3B, and the user moves the electronic pen 2 to the left as indicated by an arrow “b” while the electronic pen 2 is in contact with the operation surface 101S. Because the position indication operation to the left using the electronic pen 2 is performed while the operation button 103 is pressed, the tablet driver 3, typically, would determine that the operation is a gesture operation intended to issue the instruction to switch the target display to the display on the left.

However, because there is no display on the left side of the display 5(1) in this example, the tablet driver 3 determines that the gesture operation is a gesture operation intended to issue the instruction to switch the target display to the display 5(3) on the right end. In this way, the tablet driver 3 switches the target display from the display 5(1) illustrated with a dotted line to the display 5(3) indicated by a filled rectangle as illustrated in FIG. 3B and maintains this state. That is, the display mapped in (associated with) the tablet apparatus 1 is switched from the display 5(1) to the display 5(3).

The other operation is that, as illustrated in FIG. 3C, the user brings the electronic pen 2 into contact with the operation surface 101S while pressing the operation button 103 as indicated by an arrow “a” and widely moves the electronic pen 2 to the right as indicated by an arrow “b” while the electronic pen 2 is in contact with the operation surface 101S. Because the position indication operation to the right using the electronic pen 2 is performed while the operation button 103 is pressed, the tablet driver 3, typically, would determine that the operation is a gesture operation intended to issue the instruction to switch the target display to the display on the right side.

However, because there are two displays 5(2) and 5(3) on the right side of the display 5(1) in this example, the tablet driver 3 determines whether the received gesture operation is an instruction for switching to the display 5(2) or an instruction for switching to the display 5(3) according to the travel distance of the electronic pen 2 on the operation surface 101S. Specifically, the tablet driver 3 determines that the gesture operation is the instruction for switching to the display 5(2) if the travel distance of the electronic pen 2 on the operation surface 101S in the gesture operation is less than half the length of the operation surface 101S in the horizontal direction. The tablet driver 3 determines that the gesture operation is the instruction for switching to the display 5(3) if the travel distance of the electronic pen 2 on the operation surface 101S in the gesture operation is equal to or greater than half the length of the operation surface 101S in the horizontal direction.

In the gesture operation of the present example, the travel distance of the electronic pen 2 on the operation surface 101S is equal to or greater than half the length of the operation surface 101S in the horizontal direction as illustrated in FIG. 3C. Therefore, the tablet driver 3 determines that the gesture operation is a gesture operation intended to issue the instruction to switch the target display to the display 5(3) on the right end. In this way, the tablet driver 3 issues an instruction to the information processing apparatus 4, and as illustrated in FIG. 3C, the target display is switched from the display 5(1) illustrated with a dotted line to the display 5(3) indicated by a filled rectangle. That is, the display mapped in the tablet apparatus 1 is switched from the display 5(1) to the display 5(3).

### <Example of Using a Continuous Gesture to Switch Mapped Displays>

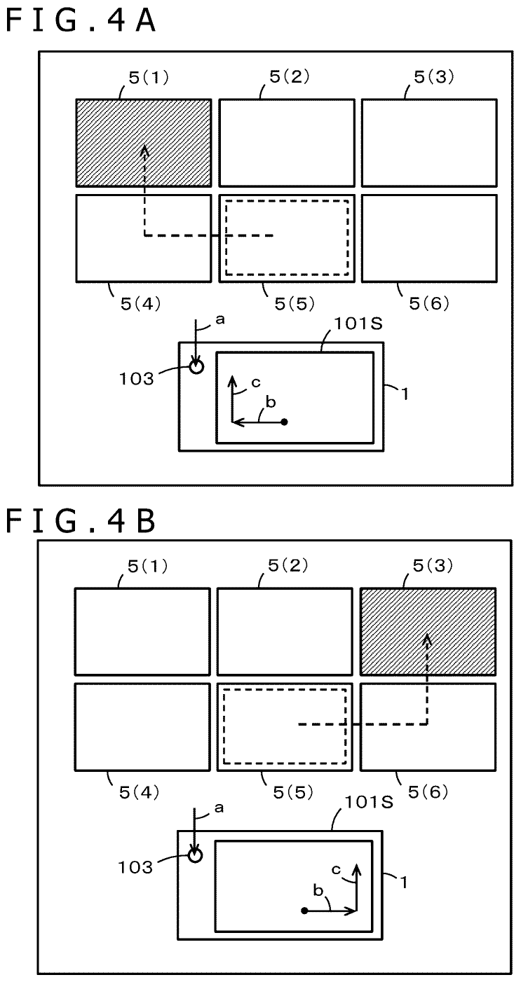

Next, as illustrated in FIGS. 4A and 4B, a case is examined in which so-called display arms or the like are used to arrange six displays 5(1) to 5(6) in a matrix, with two displays arranged in the vertical direction and three displays arranged in the horizontal direction, and the displays are connected to the information processing apparatus 4. In FIG. 4A, it is assumed that a certain process needs to be executed through the display 5(1) on the upper left side indicated by a filled rectangle when the display 5(5) on the bottom center indicated with a dotted rectangle is currently the target display. In this case, as illustrated in FIG. 4A, the user brings the electronic pen 2 into contact with the operation surface 101S while pressing the operation button 103 as indicated by an arrow “a”. The user performs an operation of moving the electronic pen 2 to the left side as indicated by an arrow “b” and moving the electronic pen 2 to the upper side as indicated by an arrow “c” while the electronic pen 2 is in contact with the operation surface 101S. In this way, the display mapped in the tablet apparatus 1 is switched from the display 5(5) to the display 5(1).

Similarly, it is assumed in FIG. 4B that a certain process needs to be executed through the display 5(3) on the upper right side indicated by a filled rectangle when the display 5(5) on the bottom center indicated with a dotted rectangle is currently the target display. In this case, as illustrated in FIG. 4B, the user brings the electronic pen 2 into contact with the operation surface 101S while pressing the operation button 103 as indicated by an arrow “a”. The user performs an operation of moving the electronic pen 2 to the right side as indicated by an arrow “b” and moving the electronic pen 2 to the upper side as indicated by an arrow “c” while the electronic pen 2 is in contact with the operation surface 101S.

That is, a continuous position indication operation may be performed, in which the electronic pen 2 is moved to the right side and moved to the upper side while the operation button 103 is pressed. Because the position indication operation is performed while the operation button 103 is pressed, the tablet driver 3 determines that the operation is a gesture operation intended to issue the instruction to switch the target display to the display 5(3) on the upper right side. As a result, the tablet driver 3 switches the target display from the display 5(5) illustrated with a dotted line to the display 5(3) indicated by a filled rectangle as illustrated in FIG. 4B and maintains this state. In this way, the display mapped in the tablet apparatus 1 is switched from the display 5(5) to the display 5(3).

Note that, in the case of FIG. 4A, the position indication operation (gesture operation) using the electronic pen 2 on the operation surface 101S of the tablet apparatus 1 may be an operation of moving the electronic pen 2 to the upper side and then moving the electronic pen 2 to the left side. This operation also causes the target display to be switched from the display 5(5) to the display 5(1). In the case of FIG. 4B, the position indication operation using the electronic pen 2 on the operation surface 101S of the tablet apparatus 1 may be an operation of moving the electronic pen 2 to the upper side and then moving the electronic pen 2 to the right side.

In the examples illustrated in FIGS. 4A and 4B, the target display can also be switched by a single gesture as in the examples described with reference to FIGS. 2A to 3C. More specifically, the position indication operation using the electronic pen 2 on the operation surface 101S of the tablet apparatus 1 may be an operation of moving the electronic pen 2 (diagonally) to the upper left in the case of FIG. 4A. The target display can be switched from the display 5(5) to the display 5(1) by this operation.

That is, the display mapped in the tablet apparatus 1 can be switched according to the direction of the movement of the electronic pen 2 based on the display (target display) currently mapped in the tablet apparatus 1. Therefore, as described above, the target display can be easily switched to the intended display based on an intuitive gesture operation using the electronic pen 2 on the tablet apparatus 1 when six displays are used to support the multi-display function. In other words, the display mapped in the tablet apparatus 1 can be switched based on an intuitive gesture operation using the electronic pen 2 on the tablet apparatus 1.

<Switching Based on a Gesture Operation while Checking State of Operation>

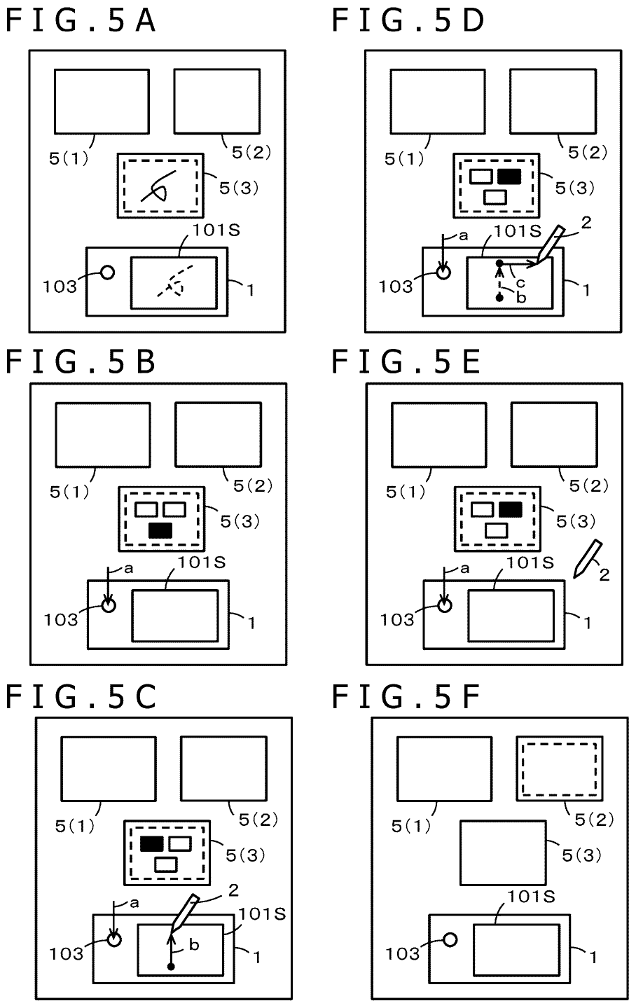

When there are a plurality of displays that can be mapped in the tablet apparatus 1, an operator may want to perform an operation while checking how the target display is being switched based on the operator's gesture operation. FIGS. 5A to 5F illustrate an example of performing an operation of switching the display (target display) mapped in the tablet apparatus 1 while checking the target display selected by the gesture operation. In this example, the operation is performed with a check flag of the tablet driver 3 set to “ON(1)”, as will be described in detail below.

FIGS. 5A to 5F illustrate a case in which the three displays 5(1), 5(2), and 5(3) are connected to the information processing apparatus 4 to support the multi-display function. Note that, in the description of this example, display arms or the like are used to arrange the display 5(1) and the display 5(2) on the upper part and arrange the display 5(3) on the bottom part. As indicated with a dotted rectangle in FIG. 5A, it is assumed that the display 5(3) on the bottom part is the target display mapped in the tablet apparatus 1. FIG. 5A illustrates a case in which a drawing application is launched in the information processing apparatus 4 and a drawing is input through the tablet apparatus 1 and is displayed on the display 5(3), which is currently the target display.

At this time, it is assumed that another application, such as a browser, needs to be launched to perform an Internet search through the display 5(2) on the upper right side. The display 5(3) is currently the target display mapped in the tablet apparatus 1 as illustrated in FIG. 5A, and the target display needs to be changed. Therefore, the user (operator) of the tablet apparatus 1 presses the operation button 103 of the tablet apparatus 1 and maintains the pressed state as illustrated in FIG. 5B. In this case, the tablet driver 3 is notified of the pressing operation on the operation button 103.

In this case, because the check flag is set to “1(ON)” as described above, the tablet driver 3 operates as follows. First, the tablet driver 3 forms a display image indicating that the display 5(3) on the bottom part is the target display. The tablet driver 3 provides the display image to the information processing apparatus 4 and instructs the information processing apparatus 4 to display the display image. In response to the instruction from the tablet driver 3, the information processing apparatus 4 displays the display image in which the target display is, for example, filled and distinguishable, on the display screen of the display 5(3) on the bottom part that is currently the target display as illustrated in FIG. 5B. In this way, the user of the tablet apparatus 1 can visually and clearly recognize that the display (target display) mapped in the tablet apparatus 1 is the display 5(3) on the bottom part.

The user of the tablet apparatus 1 brings the electronic pen 2 into contact with the operation surface 101S of the tablet apparatus 1 while pressing the operation button 103 and moves the electronic pen 2 to the upper side as indicated by an arrow “b” while the electronic pen 2 is in contact with the operation surface 101S as illustrated in FIG. 5C. The tablet apparatus 1 notifies the tablet driver 3 of information corresponding to the operation. The tablet driver 3 forms a display image indicating that the display 5(1) on the upper left side is selected as the target display. The tablet driver 3 provides the display image to the information processing apparatus 4 and instructs the information processing apparatus 4 to display the display image.

The information processing apparatus 4 displays, on the display screen of the display 5(3) which is currently the target display, the display image indicating that the display 5(1) on the upper left side is selected to be the target display, as illustrated in FIG. 5C. In the display illustrated in FIG. 5C, the display 5(1) on the upper left side is, for example, filled and displayed, such that the selection of the display 5(1) as the target display is displayed.

In the state illustrated in FIG. 5C, the intended display 5(2) is not yet selected as the target display. Therefore, the user of the tablet apparatus 1 performs an operation of moving the electronic pen 2 to the right side as indicated by an arrow “c” following the operation of moving the electronic pen 2 to the upper side as indicated by a dotted arrow “b” of FIG. 5D while pressing the operation button 103. The tablet apparatus 1 notifies the tablet driver 3 of information corresponding to the operation. The tablet driver 3 forms a display image indicating that the display 5(2) on the upper right side is selected as the target display. The tablet driver 3 provides the display image to the information processing apparatus 4 and instructs the information processing apparatus 4 to display the display image. The display 5(2) on the upper right side is, for example, filled and displayed, such that the selection of the display 5(2) as the target display is displayed.

Even when the input of an instruction with the electronic pen 2 is ended, as illustrated in FIG. 5E, the selection of the display 5(2) as the next target display is displayed on the display 5(3), which is currently the target display, as long as the pressing operation on the operation button 103 is continued. From the state of FIG. 5E, once the pressing operation on the operation button 103 ends, the tablet driver 3 switches the target display from the display 5(3) to the display 5(2), as illustrated in FIG. 5F, and maintains this state. That is, the display mapped in the tablet apparatus 1 has been changed from the display 5(3) to the display 5(2).

In the example illustrated in FIGS. 5A to 5F, the state of the changing operation of the target display can be displayed on the display screen of the target display, and the user can switch the target display while checking (confirming) the operation state. That is, the user can switch the display mapped in the tablet apparatus 1 while checking the state of the operation. Although the three displays 5(1), 5(2), and 5(3) are used to support the multi-display function in the example described in FIGS. 5A to 5F, the configuration is not limited to this example. The technique can be applied to a case of connecting any number of displays to the information processing apparatus 4 to support the multi-display function, such as a case of using six displays to support the multi-display function as described with reference to FIGS. 4A and 4B.

### <Examples of Switching Operation Modes>

As also described above, the information processing system may include multiple operation modes including the individual mapping mode and the full mapping mode. As also described above, the individual mapping mode is an operation state that allows the user to execute processing through each of connected individual displays. The full mapping mode is an operation state that allows the user to execute processing through one large display screen by assuming that the large display screen is formed by the display screens of connected multiple displays. The reason why the two operation modes are provided in this way is that the area in which the position can be indicated through the operation surface of the tablet apparatus 1 is limited. Therefore it may be necessary to specify whether the operation surface 101S of the tablet apparatus 1 is mapped to the display screens of the individual displays or mapped to the display screen of the large display including the display screens of a plurality of displays.

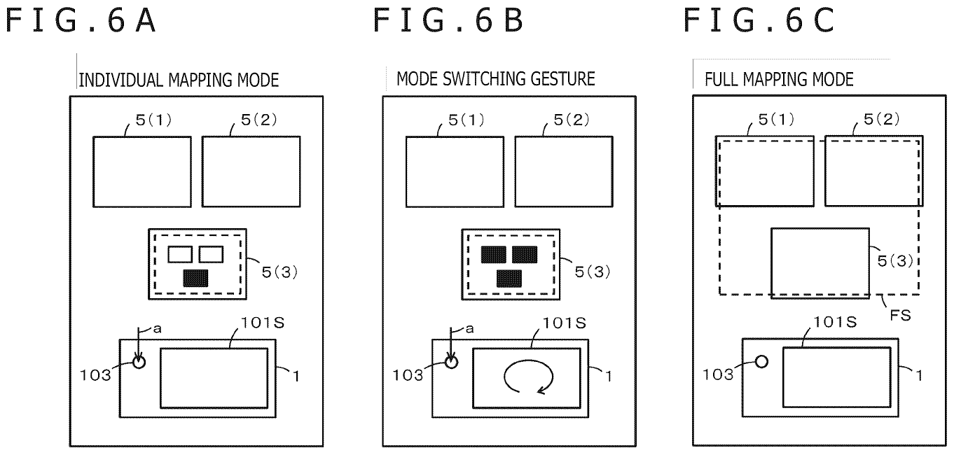

Thus, the information processing system of the embodiment is configured to allow the user to easily switch between different operations modes based on a gesture operation, as in the case of switching the display mapped to the tablet apparatus 1. FIGS. 6A to 6C are diagrams describing an example of a gesture operation to switch the operation mode. As in the case of FIGS. 5A to 5F, it is assumed in FIGS. 6A to 6C that the three displays 5(1), 5(2), and 5(3) are connected to the information processing apparatus 4 to support the multi-display function and that the check flag is set to “ON(1).”

When the operation mode needs to be switched, the user presses the operation button 103 of the tablet apparatus 1 as illustrated in FIG. 6A and maintains the pressed state. In this case, the tablet apparatus 1 notifies the tablet driver 3 of the pressing operation on the operation button 103. Because the check flag is “ON(1),” the tablet driver 3 forms a display image indicating the current target display and provides the display image to the information processing apparatus 4 as described above. At this point, the information processing system operates in the individual mapping mode. It is assumed that the display 5(3) is the target display mapped to the tablet apparatus 1, as managed by the tablet driver 3.

In this case, as illustrated in FIG. 6A, the information processing apparatus 4 displays, in response to an instruction from the tablet drive 3, a display image in which the target display is, for example, filled and distinguishable, on the display screen of the display 5(3) on the bottom part that is the target display. The display image is similar to the one displayed on the display 5(3) in FIG. 5B. It can be appreciated based on the display of the display 5(3) of FIG. 6A that the current operation mode is the “individual mapping mode” and that the display 5(3) on the bottom part is the target display mapped in the tablet apparatus 1.

In this way, the user can check that the current operation mode is the “individual mapping mode.” At this time, it is assumed that the user wants to switch the mode to the “full mapping mode.” In this case, as illustrated in FIG. 6B, the user of the tablet apparatus 1 brings the electronic pen 2 into contact with the operation surface 101S while pressing the operation button 103 and draws a large circle as indicated by an arrow on the operation surface 101S. The input of an instruction to draw the circle (a gesture operation using the electronic pen 2) is a gesture operation intended to issue an instruction to switch the operation mode. When the operation is performed, the tablet apparatus 1 notifies the tablet driver 3 of information corresponding to the operation.

The tablet driver 3 recognizes the instruction intended to switch the operation mode, on the basis of the information from the tablet apparatus 1. The tablet driver 3 changes the settings of the tablet driver 3 to switch the operation mode of the tablet apparatus 1 to the full mapping mode, which will be described in detail later. The tablet driver 3 further forms a display image indicating that the operation mode is changed to the “full mapping mode.” The tablet driver 3 provides the display image to the information processing apparats 4 and instructs the information processing apparatus 4 to display the display image. As illustrated in FIG. 6B, the information processing apparatus 4 displays, on the display screen of the current target display 5(3), the display image indicating that the mode is switched to the full mapping mode. In the display image of this case, the display corresponding to all three displays of the multi-displays is filled as illustrated in FIG. 6B, and the user is notified of the selection of the full mapping mode to use all displays at the same time.

Subsequently, when the user cancels the pressing operation on the operation button 103, a large display screen FS including the three displays 5(1), 5(2), and 5(3) is mapped to the tablet apparatus 1 as indicated by a dotted line in FIG. 6C. That is, the operation mode is changed to the “full mapping mode.” Note that the operation mode is managed by the tablet driver 3 in the information processing system of the present embodiment, which will be described in detail later.

In this way, it is assumed that the operation mode is shifted to the “full mapping mode.” In this case, coordinate data of the position indication data for writing or drawing from the tablet apparatus 1 is converted into coordinates in the memory area corresponding to the large display indicated by a dotted line in FIG. 6C, and the coordinates are provided to the information processing apparatus 4. As a result, the information processing apparatus 4 can display the image corresponding to the instruction from the tablet apparatus 1 on one large display screen FS including the displays 5(1), 5(2), and 5(3). In this way, the image is displayed on the large display screen FS indicated by the dotted line in FIG. 6C in the full mapping mode. However, no display image is visible in parts where the display screens of the displays 5(1), 5(2), and 5(3) do not exist.

Although the case of switching the individual mapping mode to the full mapping mode is described, a similar gesture operation can be performed to also switch the full mapping mode to the individual mapping mode. To switch the full mapping mode to the individual mapping mode, the display illustrated in FIG. 6A and the display illustrated in FIG. 6B are executed in reverse. In this case, after the switch to the individual mapping mode, a single display is mapped to the tablet apparatus 1 and becomes the target display.

Note that, in FIG. 6B, all three rectangles corresponding to three connected displays are filled and displayed to notify the user of the shift to the full mapping mode. However, the configuration is not limited to this example. For example, one large rectangle may be filled and displayed to notify the user of the shift to the full mapping mode. Indicia such as “full mapping mode” may be displayed to notify the user of the shift to the full mapping mode. That is, various notification methods can be used.

### [Configuration Examples of Apparatuses Included in Information Processing System]

Configuration examples of apparatuses included in the information processing system of the embodiment configured as illustrated in FIG. 1 will next be described. As described above, the multi-display function may be supported by the information processing system of the present embodiment. The information processing system allows the user to switch the target display or switch the operation mode based on a gesture operation using the electronic pen 2 on the operation surface 101S of the tablet apparatus 1, as described with reference to FIGS. 2A to 6C. The elements that realize the multi-display function include the tablet apparatus 1, the tablet driver 3, and the information processing apparatus 4 surrounded by the dotted line in FIG. 1, and the configuration examples of these elements will be described. Note that the displays 5(1), 5(2), 5(3), and so forth, can be any displays capable of being connected to the information processing apparatus 4, which is a PC in the example, and description of configuration examples of the displays will be omitted.

### <Configuration Example of Tablet Apparatus 1>

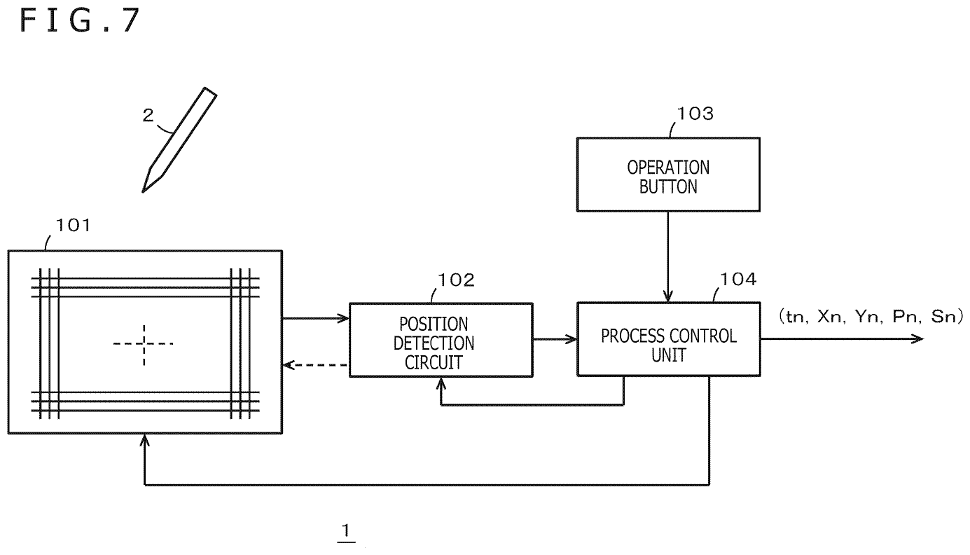

FIG. 7 is a block diagram describing a configuration example of the tablet apparatus 1 of the embodiment. As illustrated in FIG. 7, the tablet apparatus 1 includes a sensor unit 101, a position detection circuit 102, the operation button 103, and a process control unit 104. Various systems are available for detecting the position indicated between an electronic pen and a tablet apparatus. The present disclosure can be applied to electronic pens of various systems. For example, the disclosure can be applied to an electronic pen of an electromagnetic induction system or to an electronic pen of a capacitance system.

A case will be described in which the tablet apparatus 1 is of an electromagnetic induction system. In this case, a plurality of loop coils are arranged along each of an X-axis direction and a Y-axis direction to form the sensor unit 101. As described above, the operation button 103 is pressed to perform a gesture operation while indicating the gesture operation to be distinguishable from a normal position indication operation. The timing of the sensor unit 101 and the position detection circuit 102 is controlled by the process control unit 104. The position detection circuit 102 is controlled by the process control unit 104 to alternately provide a transmission period, in which power is sequentially supplied to the plurality of loop coils of the sensor unit 101 to generate a magnetic field as indicated by a dotted arrow, and a reception period, in which the supply of power is stopped to receive a magnetic field from the outside as indicted by a solid arrow.

The corresponding electronic pen 2 includes a resonant circuit formed of a coil and a capacitor, which generates a signal when a current flows through the coil in response to the magnetic field from the sensor unit 101. The electronic pen 2 adds pen pressure information to the signal and transmits the signal to the sensor unit 101. The position detection circuit 102 receives the signal through the sensor unit 101 during the reception period. The position detection circuit 102 detects an indicated position (Xn, Yn) and a pen pressure (Pn) of the electronic pen 2 and provides them to the process control unit 104. The process control unit 104 forms position indication data including a detection time point (tn) indicating the detection timing of the indicated position and the pen pressure, the indicated position (Xn, Yn), the pen pressure (Pn), and a button status (Sn) indicating whether the operation button is pressed. The process control unit 104 supplies the position indication data to the tablet driver 3.

The process control unit 104 controls switching between those loop coils, through which the sensor unit 101 transmits the signal during the transmission period, and those loop coils, through which the sensor unit 101 receives the signal during the reception period. In this way, regardless of which position on the operation surface 101S is pointed to by the electronic pen 2, the (magnetic field) signal can be reliably transmitted and received.

A case will be described in which the tablet apparatus 1 is of the capacitance system. Examples of the electronic pen of the capacitance system (so-called capacitance pens) include a conductive pen-type position indicator, and an electronic pen of an active capacitance coupling (AES) system driven by a battery and configured to transmit a signal. The electronic pen of the AES system is called an active capacitance pen or an AES pen in some cases. In the case of a AES system used with a active capacitance pen, the electronic pen is configured to add pen pressure information to a signal from an oscillation circuit mounted on the electronic pen and to transmit the signal. It is assumed that the electronic pen 2 is an AES pen in the present example.

When the tablet apparatus 1 is of the capacitance system, a plurality of linear conductors (line electrodes) are arranged in each of the X-axis direction and the Y-axis direction to form the sensor unit 101. As described above, the operation button 103 is pressed to perform a gesture operation while indicating the gesture operation to be distinguishable from a normal position indication operation. The timing of the sensor unit 101 and the position detection circuit 102 is controlled by the process control unit 104. The process control unit 104 controls switching between those line electrodes through which the position detection circuit 102 receives the signal. In this way, when the electronic pen (AES pen) 2 is brought close to the sensor unit 101, the position detection circuit 102 detects the indicated position according to the change in the capacitance (charge) generated in the linear conductor of the sensor unit 101.

In this case, the position detection circuit 102 detects the indicated position (Xn, Yn) and the pen pressure (Pn) of the electronic pen 2 and provides them to the process control unit 104. The process control unit 104 forms position indication data including the detection time point (tn) indicating the detection timing of the indicated position and the pen pressure, the indicated position (Xn, Yn), the pen pressure (Pn), and the button status (Sn) indicating whether the operation button is pressed. The process control unit 104 supplies the position indication data to the tablet driver 3. Note that, unlike in the case of an electromagnetic induction system, the transmission period and the reception period do not have to be provided in the case of a capacitance system, and the entire period can be used as the reception period.

Note that the tablet apparatus 1, when the operation button 103 is pressed or when the indication operation is performed for the sensor unit 101, forms the position indication data and supplies the position indication data to the tablet driver 3. Although the above description is directed to the tablet apparatus 1 of the electromagnetic induction system and the tablet apparatus 1 of the capacitance system, the tablet apparatus 1 is not limited to these examples. Any type of tablet apparatus 1 can be used as long as the tablet apparatus 1 can output at least the indicated position (Xn, Yn) and the button status (Sn).

### <Configuration Example of Information Processing Apparatus 4>

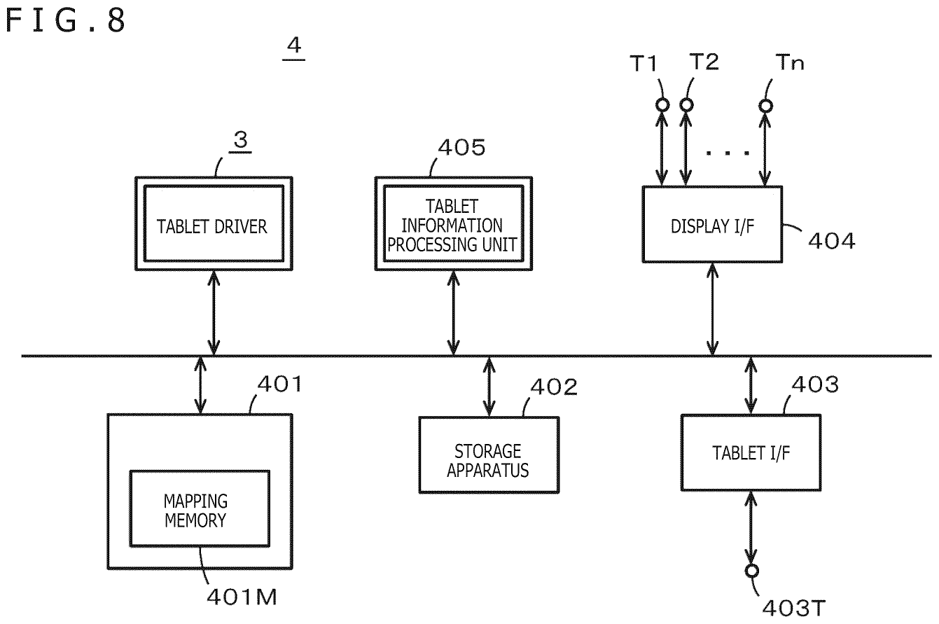

FIG. 8 is a block diagram describing a configuration example of the information processing apparatus 4 of the embodiment. As illustrated in FIG. 8, the information processing apparatus 4 includes a control unit 401, a storage apparatus 402, a tablet interface (I/F) 403, a tablet connection terminal 403T, a display I/F 404, and display connection terminals T1, T2, . . . , and Tn. The tablet driver 3 is connected to the information processing apparatus 4. The control unit 401 is a microprocessor, to which a central processing unit (CPU), a read only memory (ROM), a random access memory (RAM), a non-volatile memory, and the like (not illustrated) are connected, and the control unit 401 realizes the function of controlling the components of the information processing apparatus 4.

The control unit 401 further includes a mapping memory 401M, as illustrated in FIG. 8. The information processing apparatus 4 reserves a screen memory area in the mapping memory 401M according to a plurality of displays connected to the information processing apparatus 4 and uses the screen memory area to realize the multi-display function. The mapping memory 401M may be a dedicated memory. Note that the details of the screen memory area reserved in the mapping memory 401M of the control unit 401 will be described later.

The storage apparatus 402 is an apparatus unit formed of a recording medium, such as a solid state drive (SSD), and its driver. The storage apparatus 402 records various types of data in the recording medium and reads, changes, and deletes data recorded in the recording medium. The storage apparatus 402 stores and holds necessary data and programs, and the storage apparatus 402 is also used as a work area that temporarily stores intermediate data generated in various processes.

The tablet connection terminal 403T is an end terminal connected to the tablet apparatus 1. The tablet I/F 403 realizes a function of receiving data from the tablet apparatus 1 connected thereto through the tablet connection terminal 403T, converting the data into data in a format that can be processed in the information processing apparatus 4, and importing the data to the information processing apparatus 4. The tablet I/F 403 also realizes a function of converting, for example, control data to be provided to the tablet apparatus 1 connected thereto through the tablet connection terminal 403T into data in an output format and providing the data to the tablet apparatus 1 through the tablet connection terminal 403T.

The display connection terminals T1, T2, . . . , and Tn are end terminals connected to the displays 5(1), 5(2), . . . , and 5(n). That is, n displays can be connected at the same time to the information processing apparatus 4 to support the multi-display function. To simplify the description, it is assumed in the following description that six displays can be connected at the same time to the information processing apparatus 4.

The display I/F 404 realizes a function of receiving data from the displays connected thereto through the display connection terminals T1, T2, . . . , and Tn, converting the data into data in a format that can be processed in the information processing apparatus 4, and importing the data to the information processing apparatus 4. Therefore, characteristic information, such as a resolution, of the displays connected to the display connection terminals T1, T2, . . . , and Tn can be received from the displays, and the characteristic information can be transmitted to the control unit 401. The control unit 401 can reserve, in the mapping memory 401M, the screen memory area corresponding to the plurality of displays connected to the information processing apparatus 4, on the basis of the characteristic information of the displays received from the display I/F 404.

The display I/F 404 also converts the data provided to the displays connected thereto through the display connection terminals T1, T2, . . . , and Tn into data in an output format. The display I/F 404 realizes a function of providing the data in the output format to the displays through the display connection terminals T1, T2, . . . , and Tn.

A tablet information processing unit 405, under the control of the control unit 401, realizes a function of executing a process in response to the instruction based on the position indication data received from the tablet driver 3, as will be described later. For example, assume a case in which a drawing application is executed by the control unit 401. The tablet information processing unit 405 executes a process of forming drawing data based on the position indication data provided from the tablet apparatus 1 and providing, through the display I/F 404 under the control of the control unit 401, the drawing data to the display mapped in the tablet apparatus 1.

As a result, a drawing image corresponding to the position indication data from the tablet apparatus 1 is displayed on the display mapped in the tablet apparatus 1. In this way, the tablet information processing unit 405, on the basis of the position indication data from the tablet driver 3, forms the display information according to the process executed by the control unit 401 and supplies the display information to the display mapped in the tablet apparatus 1.

The tablet driver 3 generally has two main functions. One is that the tablet driver 3 switches the display mapped in the tablet apparatus 1, according to the gesture operation performed on the tablet apparatus 1. The other one is that the tablet driver 3 executes the process of converting the coordinate data (X-coordinate, Y-coordinate) of the position indication data according to a normal position indication operation into coordinates in the screen memory area corresponding to the display mapped in the tablet apparatus 1. In this way, the tablet apparatus 1 can be used as an input device to support the multi-display function of the information processing apparatus 4 to thereby execute various processes.

### <Configuration Example of Tablet Driver 3>

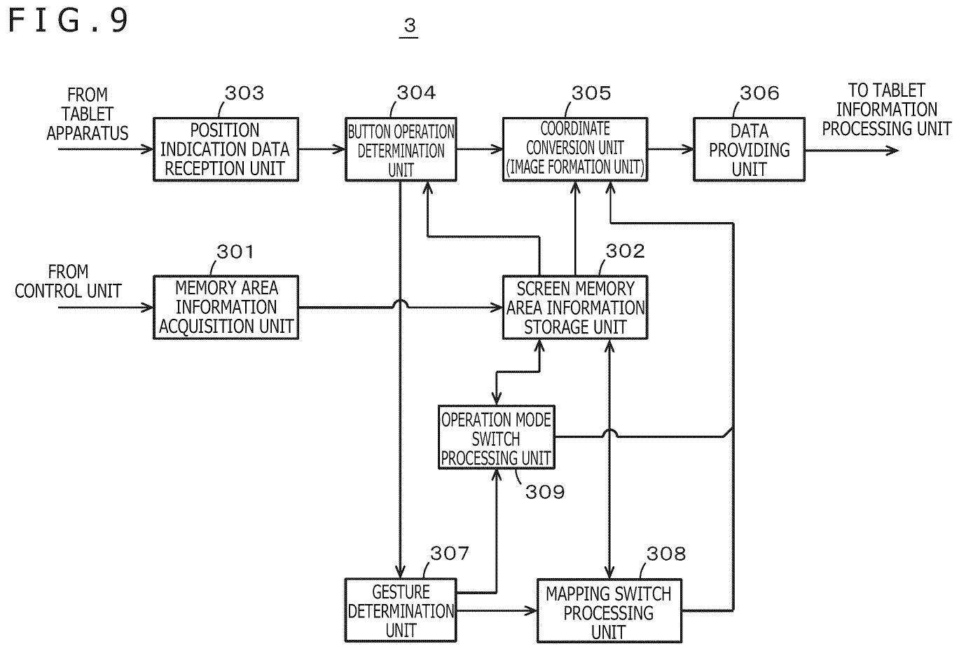

FIG. 9 is a block diagram describing a configuration example of the tablet driver 3 of the present embodiment. The tablet driver 3 generally includes three processing parts. The first processing part realizes a function of acquiring, from the information processing apparatus 4, information necessary to support the multi-display function and holding the information. The second processing part mainly realizes a function of acquiring the position indication data from the tablet apparatus 1, converting the indicated position (coordinate data) included in the position indication data as needed, and providing the indicated position to the tablet information processing unit 405. The third processing part realizes a function of switching the display mapped in the tablet apparatus 1 and a function of switching the operation mode according to a gesture operation performed on the tablet apparatus 1. These processing parts will be described below.

The first processing part includes a memory area information acquisition unit 301 and a screen memory area information storage unit 302. The memory area information acquisition unit 301 executes a process of referring to information stored in the mapping memory 401M included in the control unit 401 of the information processing apparatus 4 to acquire necessary information, and recording the information in the screen memory area information storage unit 302. Note that the process of the memory area information acquisition unit 301 is executed when the power is input to the information processing apparatus 4 or when the information stored in the mapping memory 401M is changed after an increase or decrease in the number of displays connected to the display I/F 404. Therefore, the memory area information acquisition unit 301 periodically checks the information stored in the mapping memory 401M of the control unit 401 of the information processing apparatus 4.

The screen memory area information storage unit 302 is provided, for example, in a non-volatile memory in the control unit 401, and the tablet driver 3 can access the screen memory area information storage unit 302 to write, read, change, or delete information as necessary. As described above, the information (screen memory area information) that is acquired by the memory area information acquisition unit 301 and that is necessary to support the multi-display function using the tablet apparatus 1 is stored in the screen memory area information storage unit 302. The necessary information is information related to the screen memory area reserved according to the displays connected to the information processing apparatus 4, including the information indicating the operation mode, the information indicating the display mapped in the tablet apparatus 1, and the like, as will be described in detail later.

The second processing part includes a position indication data reception unit 303, a button operation determination unit 304, a coordinate conversion unit (image formation unit) 305, and a data providing unit 306. The position indication data reception unit 303 receives the position indication data from the tablet I/F 403 and supplies the position indication data to the button operation determination unit 304. The position indication data includes the detection time point (tn), the indicated position (Xn, Yn), the pen pressure (Pn), and the button status (Sn) as described with reference to FIG. 7. The button operation determination unit 304 checks the button status (Sn) of the position indication data provided from the tablet apparatus 1 and determines whether the operation is a gesture operation. When the button operation determination unit 304 determines that the data is not the position indication data of a gesture operation, the button operation determination unit 304 supplies the position indication data to the coordinate conversion unit 305.

The coordinate conversion unit 305 refers to the screen memory area information storage unit 302 and converts the indicated position (Xn, Yn) of the supplied position indication data into coordinate data in the screen memory area of the display mapped in the tablet apparatus 1. The coordinate conversion unit 305 supplies the position indication data including the indicated position (coordinate data) obtained after the coordinate conversion to the data providing unit 306. The data providing unit 306 provides the position indication data from the coordinate conversion unit 305 to the tablet information processing unit 405 of the information processing apparatus 4. In this way, the information processing apparatus 4 executes the process corresponding to the position indication data from the tablet apparatus 1.

The third processing part includes a gesture determination unit 307, a mapping switch processing unit 308, and an operation mode switch processing unit 309. It is assumed that the button operation determination unit 304 of the second processing part has determined that the position indication data provided from the tablet apparatus 1 is the position indication data corresponding to a gesture operation. In this case, the button operation determination unit 304 checks the information stored in the screen memory area information storage unit 302 and determines whether the check flag is “ON(1).” If the button operation determination unit 304 determines that the check flag is “ON(1),” the button operation determination unit 304 instructs the coordinate conversion unit 305 to form and output a display image to notify the state of the target display or the operation mode.

In this case, the coordinate conversion unit 305 functions as the image formation unit and refers to the information stored in the screen memory area information storage unit 302 to form and output a display image to notify the current state of the target display or the operation mode. Subsequently, the coordinate conversion unit 305 functioning as the image formation unit forms and outputs a display image to notify the state of the target display or the operation mode corresponding to the gesture operation based on an instruction from the mapping switch processing unit 308 or the operation mode switch processing unit 309, to be described later. In this way, as described with reference to FIGS. 5B, 5C, 5D, 5E, 6A, and 6B, for example, the change state of the target display or the operation mode can be displayed on the display screen of the target display.

The components of the third processing part will function when the button operation determination unit 304 determines that the position indication data provided from the tablet apparatus 1 is the position indication data corresponding to a gesture operation. In this case, the button operation determination unit 304 supplies the position indication data received through the position indication data reception unit 303 to the gesture determination unit 307. The gesture determination unit 307 determines the content of the gesture operation according to the change state of the indicated position (coordinate data) included in the sequentially supplied position indication data. The gesture determination unit 307 determines whether the performed gesture operation is the instruction for switching the display mapped in the tablet apparatus 1 described with reference to FIGS. 2A to 5F or the instruction for switching the operation mode described with reference to FIGS. 6A to 6C.

It is assumed that the gesture determination unit 307 has determined that the gesture operation indicative of the instruction for switching the display mapped in the tablet apparatus 1 is performed, based on the position indication data sequentially supplied from the button operation determination unit 304. In this case, the gesture determination unit 307 instructs the mapping switch processing unit 308 to display the change state of the target display corresponding to the instruction. The mapping switch processing unit 308 refers to the check flag of the screen memory area information storage unit 302, and if the check flag is “ON(1),” the mapping switch processing unit 308 instructs the coordinate conversion unit (image formation unit) 305 to display the image obtained after changing the position of the target display in the direction corresponding to the gesture operation. In this way, the coordinate conversion unit 305 functioning as the image formation unit forms and outputs a display image indicating the switching progress of the target display, as described above. Therefore, the image can be displayed in the manner described with reference to FIGS. 5C and 5D. Note that the process is not executed if the check flag of the screen memory area information storage unit 302 is “OFF (0).”

Assume that the gesture determination unit 307 has determined that the supply of the position indication data sequentially supplied from the button operation determination unit 304 is stopped and the gesture operation indicative of the instruction for switching the display mapped in the tablet apparatus 1 is ended. In this case, the gesture determination unit 307 instructs the mapping switch processing unit 308 to switch the target display according to the instruction. The mapping switch processing unit 308, based on the instruction from the gesture determination unit 307, executes a process of changing the information indicative of the display mapped to the tablet apparatus 1 in the screen memory area information storage unit 302, to be indicative of the instructed (new) display.

Assume that the gesture determination unit 307 has determined that the performed gesture operation is the instruction for switching the operation mode. In this case, the gesture determination unit 307 instructs the operation mode switch processing unit 309 to change the operation mode. The operation mode switch processing unit 309 executes a process of changing the information indicative of the operation mode in the screen memory area information storage unit 302 in response to the instruction from the gesture determination unit 307. The operation mode switch processing unit 309 switches the mode to the full mapping mode when the operation mode information in the screen memory area information storage unit 302 indicates the individual mapping mode and, conversely, switches the mode to the individual mapping mode when the operation mode information indicates the full mapping mode.

The operation mode switch processing unit 309 refers to the check flag of the screen memory area information storage unit 302 and instructs the coordinate conversion unit (image formation unit) 305 to display an image to notify the switched operation mode if the check flag is “ON(1).” As a result, the coordinate conversion unit 305 functioning as the image formation unit forms and outputs the display image to notify the switched operation mode, as described above. Consequently, the coordinate conversion unit 305 functioning as the image formation unit forms and outputs the display image representing the switched operation mode, as also described above, and the image can be displayed in the manner described with reference to FIG. 6B. Note that the process is not executed if the check flag of the screen memory area information storage unit 302 is “OFF (0).”

In this way, the tablet driver 3 of the embodiment can switch the display mapped to the tablet apparatus 1 or switch the operation mode according to a gesture operation received from the tablet apparatus 1. As a result, a user can easily perform a desired process using an intended display among a plurality of displays connected to the information processing apparatus 4, and can easily perform a process using a large screen formed of the plurality of displays.

### [Use Cases of Multi-Display Function]

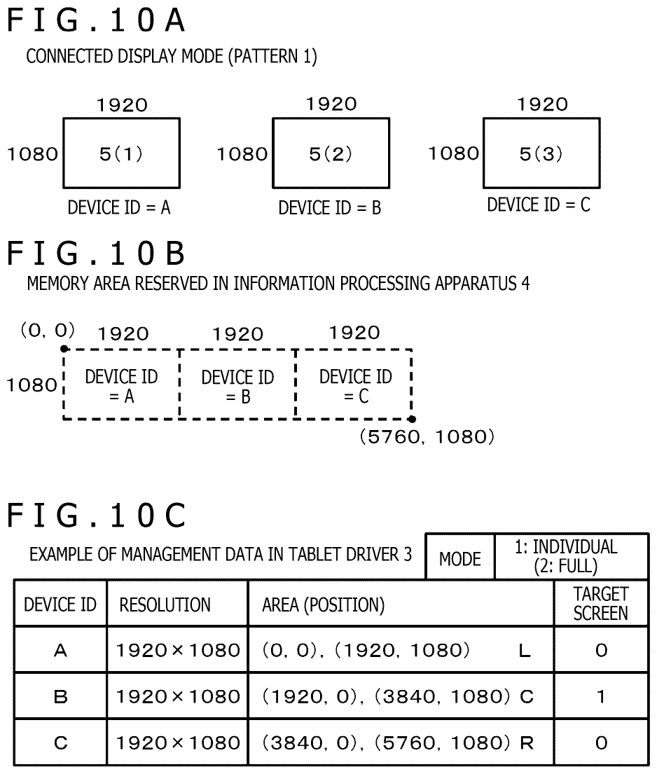

Specific use cases of the multi-display function of the information processing system of the present embodiment will be described next. FIGS. 10A to 14C are diagrams describing manners of connecting the displays to the information processing apparatus 4, screen memory areas reserved according to the connected displays, and management of the screen memory areas.

### <Case of Three Displays Arranged in Horizontal Direction>

In a case described in FIG. 10A, three displays 5(1), 5(2), and 5(3) are lined up in the horizontal direction on the desk and connected to the information processing apparatus 4 through the display connection terminals T1, T2, and T3 of the information processing apparatus 4 to support the multi-display function. Note that, in this example, the resolution of the three displays 5(1), 5(2), and 5(3) is 1920 pixels×1080 pixels, as illustrated in FIG. 10A.

In this case, attribute information, such as device identifiers (IDs) and the resolutions, of the displays 5(1), 5(2), and 5(3) connected to the information processing apparatus 4 through the display connection terminals T1, T2, and T3, is acquired through the display I/F 404, and the control unit 401 is notified of the attribute information. The user uses the tablet apparatus 1 and the electronic pen 2 to define the display setting of the information processing apparatus 4. The control unit 401 configures the display setting according to the instruction input by the user received through the tablet connection terminal and the tablet I/F 403, and receives input of settings necessary for realizing the multi-display function, such as the arrangement order of displays. It is assumed below that, in the initial state, predetermined displays are mapped in the tablet apparatus 1 according to the number of connected displays.

As a result, the control unit 401 reserves the memory area in the mapping memory 401M on the basis of the attribute information from the connected the displays 5(1), 5(2), and 5(3) and the predefined information such as the information indicating the order of displays. In the present example, a memory area corresponding to the large display screen formed of the displays 5(1), 5(2), and 5(3) with the resolution of 1920 pixels×1080 pixels, which are lined up in the horizontal direction, is reserved as illustrated in FIG. 10B. The memory area is a rectangular memory area in which the upper left corner of the diagonal is the origin (0, 0) and the bottom right corner of the diagonal is the maximum value (5760, 1080). In the present example, three memory areas partitioned by dotted lines in the large memory area corresponding to the large display screen are memory areas mapped to (allocated to) the displays 5(1), 5(2), and 5(3).

Therefore, the area on the left end side is the memory area mapped to the display 5(1) specified by device ID=A. The area at the center is the memory area mapped to the display 5(2) specified by device ID=B. The area on the right side is the memory area mapped to the display 5(3) specified by device ID=C. In this way, the memory area information including the arrangement positions of the displays connected to the information processing apparatus 4 and the memory areas allocated to the displays is formed in the mapping memory 401M of the control unit 401 of the information processing apparatus 4.

As described above, in the individual mapping mode, a memory area is allocated to one display mapped in the tablet apparatus 1, and the display process is executed on that display. In the full mapping mode, a large memory area is allocated to the large display screen formed of a plurality of displays connected to the information processing apparatus 4, and the display process is executed on the large display screen including the plurality of displays.

Although not illustrated in FIG. 10B, the display connection terminals are managed so that it can be identified to which display connection terminal the display specified by the device ID is connected. Therefore, in the present example, the information processing apparatus 4 identifies that the display 5(1) is connected to the connection terminal T1, the display 5(2) is connected to the connection terminal T2, and the display 5(3) is connected to the connection terminal T3.

The memory area information acquisition unit 301 of the tablet driver 3 acquires the information stored in the mapping memory 401M of the information processing apparatus 4, adds necessary information to the stored information to form screen memory area information, and records the screen memory area information in the screen memory area information storage unit 302 in a manner illustrated in FIG. 10C. As illustrated in FIG. 10C, the screen memory area information stored in the screen memory area information storage unit 302 includes the device ID, the resolution, the area, the target screen, and the operation mode. Therefore, in the present example, it is possible to determine from the information stored in the screen memory area information storage unit 302 that three displays with device IDs “A,” “B,” and “C” are connected to the information processing apparatus 4 and that the resolution of the displays is “1920 pixels×1080 pixels.”

Therefore, the positions of the displays can be determined as indicated by characters L, C, and R on the right end side in the field of “area (position)”. More specifically, it can be determined that the display 5(1) with the device ID “A” is positioned on the left side (L), the display 5(2) with the device ID “B” is positioned at the center C, and the display 5(3) with the device ID “C” is positioned on the right side (R).

The field of “target screen” identifies that the display 5(2) with the device ID “B” positioned at the center is currently the target display (target screen) mapped in the tablet apparatus 1. The screen memory area information storage unit 302 also manages the information indicating the operation mode, as illustrated on the upper right part of FIG. 10C. The information indicates that the current operation mode of the multi-display function of the information processing system is the individual mapping mode.

The screen memory area information described with reference to FIG. 10C is prepared in the screen memory area information storage unit 302 of the tablet driver 3, and this supports switching of the target display based on a gesture operation described with reference to FIGS. 2A to 3C. More specifically, it is assumed that the three displays 5(1), 5(2), and 5(3) are connected to the information processing apparatus 4 as described with reference to FIG. 10C. In this case, it is assumed that the display 5(2) with the device ID “B” positioned at the center is determined to be mapped to the tablet apparatus 1.

In this case, as illustrated in FIG. 2B, it is assumed that the user, while pressing the operation button 103 of the tablet apparatus 1, performs the gesture operation of bringing the electronic pen 2 into contact with the operation surface 101S and moving the electronic pen 2 to the left side. In this case, the information in the field of “target screen” included in the information stored in the screen memory area information storage unit 302 is rewritten by the functions of the button operation determination unit 304, the gesture determination unit 307, and the mapping switch processing unit 308 of the tablet driver 3. Specifically, the field of “target screen” of the display 5(1) with the device ID “A” positioned on the left side is set to “1 (ON),” and the field of “target screen” of the display 5(2) with the device ID “B” positioned at the center is set to “0 (OFF).” In this way, the display mapped in the tablet apparatus 1 is switched to the display 5(1) on the left side.

Subsequently, it is assumed that the user performs a normal position indication operation on the operation surface 101S of the tablet apparatus 1, without pressing on the operation button 103. In this case, the coordinate conversion unit 305 of the tablet driver 3 converts the coordinate data included in the position indication data from the tablet apparatus 1 into the coordinates of the memory area of the display 5(1) on the left side mapped in the tablet apparatus 1. More specifically, the process is executed by determining that the position indication operation is performed in the memory area ((0, 0), (1920, 1080)), and the position indication data including the coordinate data obtained after the process (after the conversion) is supplied to the tablet information processing unit 405. In this way, the result corresponding to the position indication operation performed on the tablet apparatus 1 is displayed on the display 5(1) on the left side.

### <Case of Two Displays Arranged in Vertical Direction and Three Displays Arranged in Horizontal Direction>

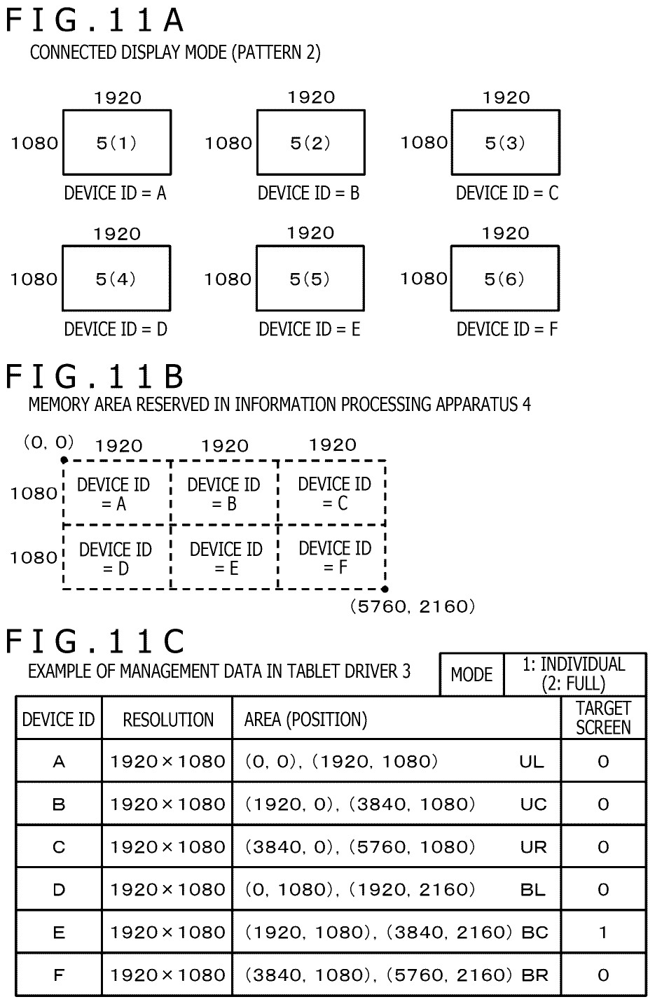

In a case described in FIG. 11A, six displays 5(1) to 5(6) are arranged in a 2× 3 matrix and connected to the information processing apparatus 4 through the display connection terminals T1 to T6 of the information processing apparatus 4 to support the multi-display function. In this example, the resolution of the six displays 5(1) to 5(6) is 1920 pixels×1080 pixels.

As in the case of the example illustrated in FIGS. 10A to 10C, attribute information, such as device IDs and resolutions, of the displays 5(1) to 5(6) connected to the information processing apparatus 4 through the display connection terminals T1 to T6, is acquired through the display I/F 404, and the control unit 401 is notified of the attribute information. The control unit 401 defines the display setting according to the instruction input by the user received through the tablet connection terminal and the tablet I/F 403, and receives input of settings necessary for using the multi-display function, such as the order of displays.

The control unit 401 reserves the memory area in the mapping memory 401M on the basis of the attribute information from the connected displays 5(1) to 5(6) and the information indicating predefined settings such as the order of displays. In this example, a memory area corresponding to the large display screen formed when the displays 5(1) to 5(6) are arranged in a 2× 3 matrix is reserved as illustrated in FIG. 11B. The memory area is a rectangular memory area in which the upper left corner of the diagonal is the origin (0, 0) and the bottom right corner of the diagonal is the maximum value (5760, 2160). In this example, six memory areas partitioned by dotted lines in the large memory area corresponding to the large display screen are memory areas mapped to (allocated to) the displays 5(1) to 5(6).

Therefore, the area on the upper left side is the memory area mapped to the display 5(1) specified by device ID=A. The area on the upper center is the memory area mapped to the display 5(2) specified by device ID=B. The area on the upper right side is the memory area mapped to the display 5(3) specified by device ID=C.

The area on the lower left side is the memory area mapped to the display 5(4) specified by device ID=D. The area on the bottom center is the memory area mapped to the display 5(5) specified by device ID=E. The area on the bottom right side is the memory area mapped to the display 5(6) specified by device ID=F. Such information related to the memory areas is formed in the mapping memory 401M of the control unit 401 of the information processing apparatus 4.

The memory area information acquisition unit 301 of the tablet driver 3 acquires the information stored in the mapping memory 401M of the information processing apparatus 4, adds necessary information to the stored information to form screen memory area information, and records the screen memory area information in the screen memory area information storage unit 302 in a manner illustrated in FIG. 11C. As illustrated in FIG. 11C, the screen memory area information stored in the screen memory area information storage unit 302 includes the device ID, the resolution, the area, the target screen, and the operation mode. Therefore, in this example, six displays with device IDs “A,” “B,” “C,” “D,” “E,” and “F” are connected to the information processing apparatus 4, and the resolution of the displays is “1920 pixels×1080 pixels” according to the information stored in the screen memory area information storage unit 302.

Therefore, the positions of the displays can be determined as indicated by characters UL, UC, UR, BL, BC, BR on the right end side in the field of “area (position).” More specifically, it can be determined that the display 5(1) with the device ID “A” is positioned on the upper left side (UL), the display 5(2) with the device ID “B” is positioned on the upper center (UC), and the display 5(3) with the device ID “C” is positioned on the upper right side (UR). It can also be determined that the display 5(4) with the device ID “D” is positioned on the bottom left side (BL), the display 5(5) with the device ID “E” is positioned on the bottom center (BC), and the display 5(6) with the device ID “F” is positioned on the bottom right side (BR).

The field of “target screen” identifies that the display 5(5) with the device ID “E” positioned on the bottom center is currently the target display (target screen) mapped to the tablet apparatus 1. The screen memory area information storage unit 302 also manages the information indicating the operation mode, as illustrated on the upper right part of FIG. 11C. The information indicates that the current operation mode of the multi-display function of the information processing system is the individual mapping mode. The screen memory area information described with reference to FIG. 11C is prepared in the screen memory area information storage unit 302 of the tablet driver 3, and this supports switching of the target display based on a gesture operation described with reference to FIGS. 4A and 4B.

In this case, as illustrated in FIG. 4A, it is assumed that the user, while pressing the operation button 103 of the tablet apparatus 1, performs the gesture operation of bringing the electronic pen 2 into contact with the operation surface 101S and moving the electronic pen 2 to the left side and then to the upper side. In this case, the information in the field of “target screen” included in the information stored in the screen memory area information storage unit 302 is rewritten by the functions of the button operation determination unit 304, the gesture determination unit 307, and the mapping switch processing unit 308 of the tablet driver 3. Specifically, the field of “target screen” of the display 5(1) with the device ID “A” positioned on the upper left side is set to “1 (ON),” and the field of “target screen” of the display 5(5) with the device ID “E” positioned on the bottom center is set to “0 (OFF).” In this way, the display mapped in the tablet apparatus 1 is switched to the display 5(1) on the upper left side.

Subsequently, it is assumed that the user performs a normal position indication operation on the operation surface 101S of the tablet apparatus 1, without pressing on the operation button 103. In this case, the coordinate conversion unit 305 of the tablet driver 3 converts the coordinate data included in the position indication data from the tablet apparatus 1 into the coordinates of the memory area of the display 5(1) on the upper left side mapped in the tablet apparatus 1. More specifically, the process is executed by determining that the position indication operation is performed in the memory area ((0, 0), (1920, 1080)), and the position indication data including the coordinate data obtained after the process (after the conversion) is supplied to the tablet information processing unit 405. In this way, the result corresponding to the position indication operation performed on the tablet apparatus 1 is displayed on the display 5(1) on the upper left side.

### <Case of Two Displays Arranged on Upper Part and One Display Arranged on Lower Part>

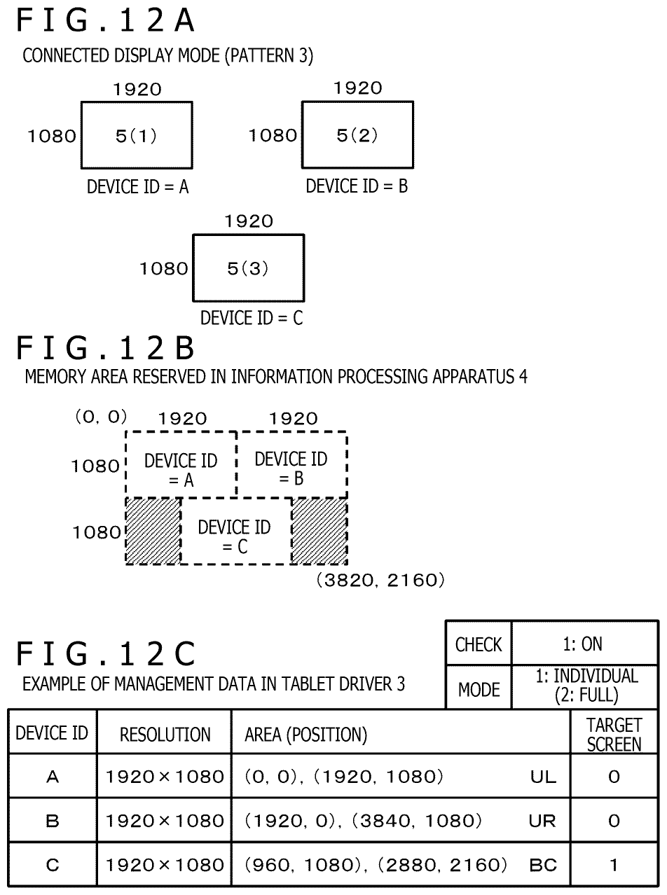

In a case described in FIG. 12A, the displays 5(1), 5(2), and 5(3) are arranged and connected to the information processing apparatus 4 through the display connection terminals T1, T2, and T3 of the information processing apparatus 4 to support the multi-display function. More specifically, three displays including two displays on the upper part and one display on the bottom part are arranged and connected to the information processing apparatus 4 in this example. The resolution of the three displays 5(1), 5(2), and 5(3) is 1920 pixels×1080 pixels in this example.

As in the case described with reference to FIGS. 10A to 10C, attribute information, such as the device IDs and the resolutions, of the displays 5(1), 5(2), and 5(3) connected to the information processing apparatus 4 through the display connection terminals T1, T2, and T3, is acquired through the display I/F 404, and the control unit 401 is notified of the attribute information. The control unit 401 defines the display setting according to the instruction input by the user received through the tablet connection terminal and the tablet I/F 403 and receives input of settings necessary to support the multi-display function such as the order of displays.

The control unit 401 reserves a memory area in the mapping memory 401M on the basis of the attribute information from the connected displays 5(1), 5(2), and 5(3) and the predefined information such as information indicating the order of displays. In this example, a screen memory area corresponding to the large display screen formed when the displays 5(1), 5(2), and 5(3) are arranged, with two on the upper part and one on the bottom part, is reserved as illustrated in FIG. 12B. The screen memory area is a rectangular memory area in which the upper left corner of the diagonal is the origin (0, 0) and the bottom right corner of the diagonal is the maximum value (3820, 2160).

In the case of this example, three memory areas partitioned by dotted lines in the large memory area corresponding to the large display screen are memory areas mapped to (allocated to) the displays 5(1), 5(2), and 5(3). Note that the screen memory area corresponding to the large display screen obtained by putting together the display screens of the three displays 5(1), 5(2), and 5(3) is a rectangular area with 3820 pixels×2160 pixels as illustrated in FIG. 12B. However, in the parts marked with hatching (oblique lines), there exists no display screen of any display, and no image is displayed and no display image is observable in the full mapping mode.

Thus, the area on the upper left side is the memory area mapped to the display 5(1) specified by device ID=A. The area on the upper right side is the memory area mapped to the display 5(2) specified by device ID=B. The area on the bottom center is the memory area mapped to the display 5(3) specified by device ID=C. Such memory area information is formed in the mapping memory 401M of the control unit 401 of the information processing apparatus 4.

The memory area information acquisition unit 301 of the tablet driver 3 acquires the information stored in the mapping memory 401M of the information processing apparatus 4, adds necessary information to the stored information to form screen memory area information, and records the screen memory area information in the screen memory area information storage unit 302 in a manner illustrated in FIG. 12C. As illustrated in FIG. 12C, the screen memory area information stored in the screen memory area information storage unit 302 includes the device ID, the resolution, the area, the target screen, the operation mode, and the check flag. Therefore, in the case of this example, it can be determined based on the information stored in the screen memory area information storage unit 302 that three displays with the device IDs “A,” “B,” and “C” are connected to the information processing apparatus 4 and that the resolution of the displays is “1920 pixels×1080 pixels.”

Therefore, the positions of the displays can be determined as indicated by characters UL, UR, and BC on the right end side in the field of “area (position)”. More specifically, it can be determined that the display 5(1) with the device ID “A” is positioned on the upper left side (UL), the display 5(2) with the device ID “B” is positioned on the upper right side (UR), and the display 5(3) with the device ID “C” is positioned on the bottom center (BC). It can also be determined based on the field of “target screen” that the display 5(3) with the device ID “C” positioned on the bottom center is currently the target display (target screen) mapped in the tablet apparatus 1.

The screen memory area information storage unit 302 also manages the information indicating the operation mode, as illustrated on the upper right part of FIG. 12C. The information indicates that the current operation mode of the multi-display function of the information processing system is the individual mapping mode. Although not illustrated in FIGS. 10A to 11C, the screen memory area information storage unit 302 further manages the information indicating the check flag, as illustrated on the upper right part of FIG. 12C. When the check flag is set to “ON(1),” the state of the target display and the operation mode can be displayed and confirmed, as described with reference to FIGS. 5A to 6C.

The screen memory area information described with reference to FIG. 12C is prepared in the screen memory area information storage unit 302 of the tablet driver 3, and this supports switching of the target display based on a gesture operation described with reference to FIGS. 5A to 5F. That is, it can be determined that the three displays 5(1), 5(2), and 5(3) are connected to the information processing apparatus 4, with two on the upper part and one on the bottom part, as described with reference to FIG. 12C. It is also determined that the display 5(3) with the device ID “C” positioned on the bottom center is mapped to the tablet apparatus 1 and is the target display. It is assumed that the check flag is set to “ON(1)” and the operation mode is set to “1: individual mapping mode” in the screen memory area information storage unit 302 of the tablet driver 3, as illustrated in FIG. 12C.

To switch the target display in this case, when the user presses the operation button 103 of the tablet apparatus 1, the tablet apparatus 1 supplies the position indication data with the button status (Sn) switched to “ON(1)” to the information processing apparatus 4. In the tablet driver 3, the coordinate conversion unit (image formation unit) 305 refers to the information stored in the screen memory area information storage unit 302 and forms and outputs a display image indicating the current target display in response to the instruction from the button operation determination unit 304. In this way, the tablet information processing unit 405 of the information processing apparatus 4 displays an indication of the current target display on the display screen of the current target display, as illustrated in the display 5(3) of FIG. 5B.

Subsequently, it is assumed that the user performs a gesture operation of bringing the electronic pen 2 into contact with the operation surface 101S and moving the electronic pen 2 to the upper side and then to the right side while pressing the operation button 103 of the tablet apparatus 1. In this case, the changing state of the target display is displayed.

Subsequently, it is assumed that the gesture determination unit 307 of the tablet driver 3 determines that the gesture operation is ended. In this case, the information in the field of “target screen” included in the information stored in the screen memory area information storage unit 302 is rewritten by the functions of the button operation determination unit 304 and the mapping switch processing unit 308. Specifically, the field of “target screen” of the display 5(2) with the device ID “B” positioned on the upper right side is set to “1 (ON),” and the field of “target screen” of the display 5(3) with the device ID “C” positioned on the bottom center is set to “0 (OFF).” In this way, the display mapped in the tablet apparatus 1 is switched from the display 5(3) on the bottom center to the display 5(2) on the upper right side.

Subsequently, it is assumed that the user performs a normal position indication operation on the operation surface 101S of the tablet apparatus 1, without pressing on the operation button 103. In this case, the coordinate conversion unit 305 of the tablet driver 3 converts the coordinate data included in the position indication data from the tablet apparatus 1 into the coordinates of the memory area of the display 5(2) on the upper right side mapped in the tablet apparatus 1. More specifically, the process is executed by determining that the position indication operation is performed in the memory area ((1920, 0), (3840, 1080)), and the position indication data including the coordinate data obtained after the process (after the conversion) is supplied to the tablet information processing unit 405. In this way, the result corresponding to the position indication operation performed on the tablet apparatus 1 is displayed on the display 5(2) on the upper right side.

In this way, when the check flag is set to “ON(1),” the display mapped in the tablet apparatus 1 is changed according to a gesture operation using the electronic pen 2, and the change status can be checked (confirmed) in the display image, as described with reference to FIGS. 5A to 5F. In this way, the user can switch the target display mapped to the tablet apparatus 1 by confirming that the intended display is successfully indicated (designated) as the display to be mapped to the tablet apparatus 1. Similarly, when the check flag is set to “ON(1),” the operation mode is changed in according to the gesture operation using the electronic pen 2, and the change status can be checked in the display image, as described with reference to FIGS. 6A to 6C.

<Multi-Display Function Using Displays with Different Resolutions>

In the examples described with reference to FIGS. 10A to 12C, a plurality of displays with the same resolution are connected to the information processing apparatus 4 to support the multi-display function. However, a plurality of displays with different resolutions may be connected to the information processing apparatus 4 to support the multi-display function in some cases. This disclosure can also be applied to the case of connecting the displays with different resolutions to the information processing apparatus 4 to support the multi-display function.

<Case of Arranging Displays with Different Resolutions in Horizontal Direction (Horizontal Arrangement)>

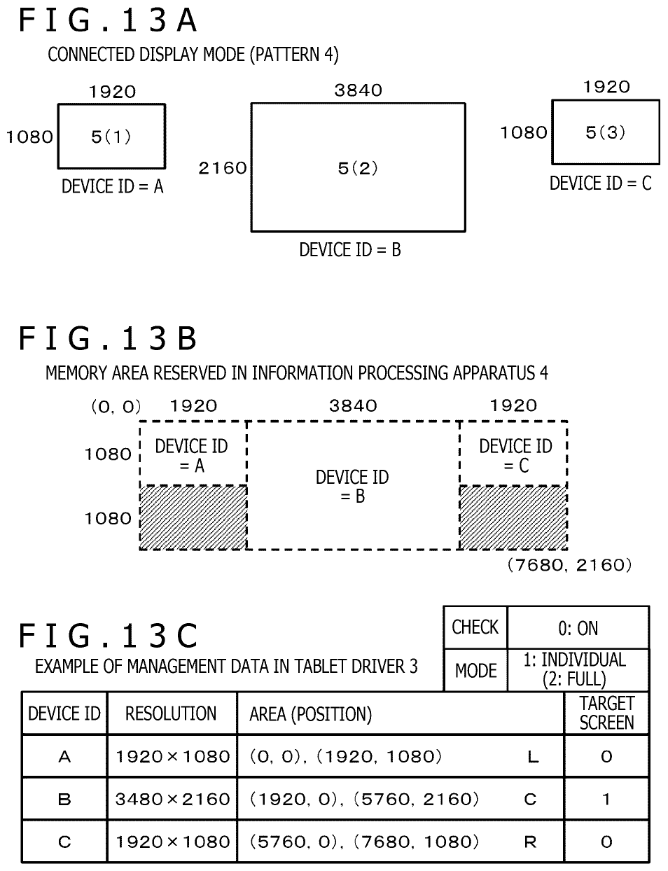

In a case described in FIG. 13A, three displays 5(1), 5(2), and 5(3) are lined up in the horizontal direction on the desk and connected to the information processing apparatus 4 through the display connection terminals T1, T2, and T3 of the information processing apparatus 4 to support the multi-display function. Note that, in this example, the resolution of the display 5(1) arranged on the left side and the display 5(3) arranged on the right side is 1920 pixels×1080 pixels. On the other hand, the resolution of the display 5(2) arranged at the center is 3840 pixels×2160 pixels.

The control unit 401 of the information processing apparatus 4 reserves a memory area in the mapping memory 401M on the basis of the attribute information of the displays 5(1), 5(2), and 5(3) and the defined display setting information as in the cases described with reference to FIGS. 10A to 12C. In this example, a memory area corresponding to the large display screen including the display screens of the three displays is reserved as illustrated in FIG. 13B. The memory area is a rectangular memory area in which the upper left corner of the diagonal is the origin (0, 0) and the bottom right corner of the diagonal is the maximum value (7680, 2160) as illustrated in FIG. 13B.

The screen memory area corresponding to the large display screen obtained by putting together the display screens of the three displays 5(1), 5(2), and 5(3) is a rectangular area with 7680 pixels×2160 pixels as illustrated in FIG. 13B. Therefore, the area on the left end side is the memory area mapped for the display 5(1) specified by device ID=A. The area at the center is the memory area mapped for the display 5(2) specified by device ID=B. The area on the left side is the memory area mapped for the display 5(3) specified by device ID=C.

The memory area information acquisition unit 301 of the tablet driver 3 acquires the information stored in the mapping memory 401M of the information processing apparatus 4, adds necessary information to the stored information to form screen memory area information, and records the screen memory area information in the screen memory area information storage unit 302 in a manner illustrated in FIG. 13C. As illustrated in FIG. 13C, the information stored in the screen memory area information storage unit 302 includes the device ID, the resolution, the area, the target screen, the operation mode, and the check flag. Therefore, in the case of this example, it is determined from the information stored in the screen memory area information storage unit 302 that three displays with the device IDs “A,” “B,” and “C” are connected to the information processing apparatus 4. It is also determined that the resolution of the displays with the device IDs “A” and “C” is “1920 pixels×1080 pixels” and that the resolution of the display with the device ID “B” is “3480 pixels×2160 pixels.”

Therefore, the positions of the displays can be determined as indicated by characters L, C, and R on the right end side in the field of “area (position)”. More specifically, it can be determined that the display 5(1) with the device ID “A” is positioned on the left side (L), the display 5(2) with the device ID “B” is positioned at the center (C), and the display 5(3) with the device ID “C” is positioned on the right side (R).

It is assumed that the information related to the screen memory area described with reference to FIG. 13C is held in the screen memory area information storage unit 302 of the tablet driver 3. In this case, switching of the target display described with reference to FIGS. 2A to 3C and switching of the operation mode described with reference to FIGS. 6A to 6C can be easily performed based on a gesture operation using the electronic pen 2.

<Case of Arranging Displays with Different Resolutions in Vertical Direction (Vertical Arrangement)>

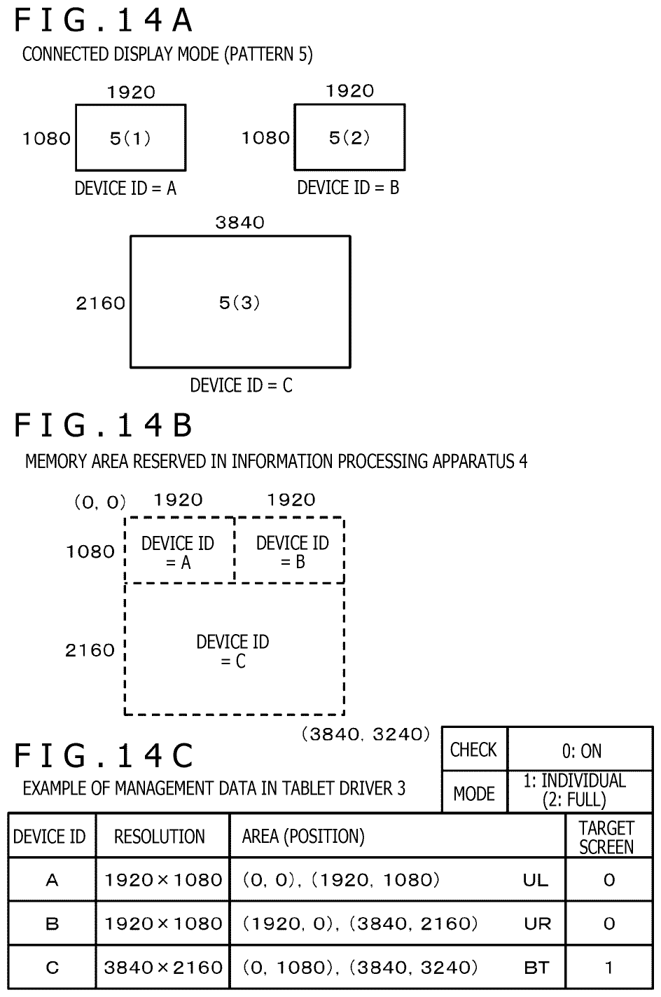

In a case described in FIG. 14A, so-called display arms or the like are used to arrange the three displays 5(1), 5(2), and 5(3), with the displays 5(1) and 5(2) above the display 5(3). In this example, the three displays 5(1), 5(2), and 5(3) are connected to the information processing apparatus 4 through the display connection terminals T1, T2, and T3 of the information processing apparatus 4 to support the multi-display function. It is assumed in this example that the resolution of the display 5(1) and the display 5(2) is 1920 pixels×1080 pixels and the resolution of the display 5(3) is 3840 pixels×2160 pixels, as illustrated in FIG. 14A.

The control unit 401 of the information processing apparatus 4 reserves a memory area in the mapping memory 401M on the basis of the attribute information of the displays 5(1), 5(2), and 5(3) and the defined display setting information, as in the cases described with reference to FIGS. 10A to 12C. In the case of this example, a memory area corresponding to the large display screen including the display screens of the three displays is reserved as illustrated in FIG. 14B. The memory area is a rectangular memory area in which the upper left corner of the diagonal is the origin (0, 0) and the bottom right corner of the diagonal is the maximum value (3840, 3240) as illustrated in FIG. 14B.

In the case of this example, three memory areas partitioned by dotted lines in the large memory area corresponding to the large screen are memory areas mapped to (allocated to) the displays 5(1), 5(2), and 5(3). Note that the memory area corresponding to the large display screen obtained by putting together the display screens of the three displays 5(1), 5(2), and 5(3) is a rectangular area with 3840 pixels×3240 pixels as illustrated in FIG. 14B.

Therefore, the area on the upper left side is the memory area mapped for the display 5(1) specified by device ID=A. The area on the upper right side is the memory area mapped for the display 5(2) specified by device ID=B. The area on the bottom part is the memory area mapped for the display 5(3) specified by device ID=C.

Note that, in the case of the example illustrated in FIG. 14B, unlike in the case of FIG. 13B, all parts of the reserved screen memory area correspond to display screens. Therefore, in the full mapping mode, there is no area in which an image is not displayed. The memory area information described with reference to FIG. 14B is formed in the mapping memory 401M of the control unit 401 of the information processing apparatus 4.

The memory area information acquisition unit 301 of the tablet driver 3 acquires the information stored in the mapping memory 401M of the information processing apparatus 4, adds necessary information to the stored information to form screen memory area information, and records the screen memory area information in the screen memory area information storage unit 302 in a manner illustrated in FIG. 14C. As illustrated in FIG. 14C, the information stored in the screen memory area information storage unit 302 includes the device ID, the resolution, the area, the target screen, the operation mode, and the check flag. Therefore, in the case of this example, it is determined from the information stored in the screen memory area information storage unit 302 that three displays with the device IDs “A,” “B,” and “C” are connected to the information processing apparatus 4. It is also determined that the resolution of the displays with the device IDs “A” and “B” is “1920 pixels×1080 pixels” and that the resolution of the display with the device ID “C” is “3480 pixels×2160 pixels.”

Therefore, the positions of the displays can be determined as indicated by characters UL, UR, and BT on the right end side in the field of “area (position)”. More specifically, it can be determined that the display 5(1) with the device ID “A” is positioned on the upper left side (UL), the display 5(2) with the device ID “B” is positioned on the upper right side (UR), and the display 5(3) with the device ID “C” is positioned on the bottom part (BT).

It can be determined that, in the field of “target screen”, the display 5(3) with the device ID “C” positioned on the bottom part is currently the target display (target screen) mapped to the tablet apparatus 1. The screen memory area information storage unit 302 also manages the information indicating the operation mode and the information indicating the check flag, as illustrated on the upper right part of FIG. 14C. The information indicates that the current operation mode of the multi-display function of the information processing system is the individual mapping mode, and the check flag is “ON(1).”

It is assumed that the information related to the screen memory area described with reference to FIG. 14C is held in the screen memory area information storage unit 302 of the tablet driver 3. In this case, switching of the target display described with reference to FIGS. 5A to 5F and switching of the operation mode described with reference to FIGS. 6A to 6C can easily be performed based on a gesture operation using the electronic pen 2.

### [Summary of Tablet Driver 3 Operation]

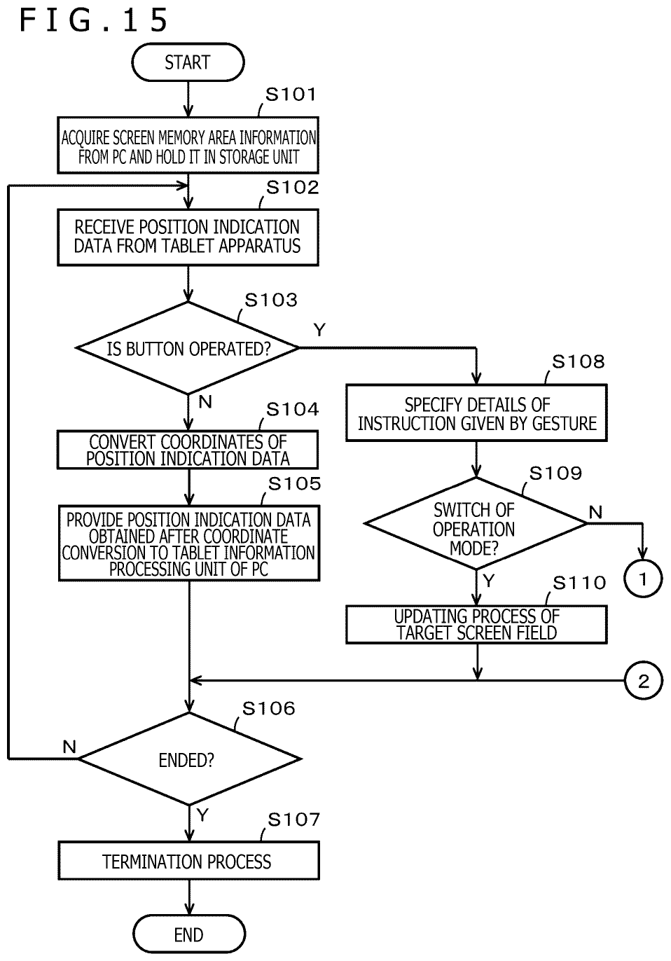

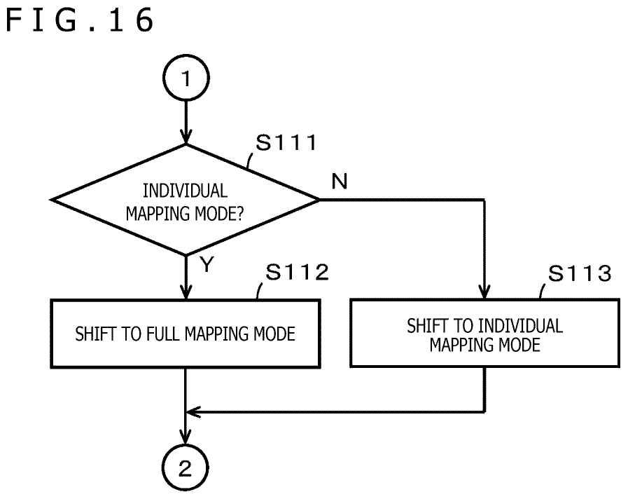

FIGS. 15 and 16 are a flow chart describing the process executed by the tablet driver apparatus of the embodiment. The tablet driver 3 functions to execute the process illustrated in the flow chart of FIGS. 15 and 16 when the plurality of displays 5(1), 5(2), 5(3), . . . are connected to the information processing apparatus 4 and the power is input to the information processing apparatus 4 connected to the tablet apparatus 1.

In the tablet driver 3, first, the memory area information acquisition unit 301 functions. The memory area information acquisition unit 301 acquires the information stored in the mapping memory 401M of the information processing apparatus 4, adds the necessary information, such as the operation mode and the check flag, to the stored information to form the screen memory area information, and stores the screen memory area information in the screen memory area information storage unit 302 (step S101). The information stored in the mapping memory 401M is the information described with reference to FIGS. 10B, 11B, 12B, 13B, and 14B. The screen memory area information is the information described with reference to FIGS. 10C, 11C, 12C, 13C, and 14C.

Subsequently, the tablet driver 3 receives the position indication data from the tablet apparatus 1 through the position indication data reception unit 303 of the tablet driver 3 and supplies the position indication data to the button operation determination unit 304 (step S102). The button operation determination unit 304 refers to the button status (Sn) of the supplied position indication data and determines whether the operation button 103 is pressed (step S103). The determination process of step S103 is a process of determining whether the received position indication data corresponds to a normal operation for writing, drawing, or the like or corresponds to a gesture operation performed while the operation button 103 is pressed.

It is assumed that the button operation determination unit 304 determines in the determination process of step S103 that a pressing operation on the operation button 103 is not involved (i.e., the position indication data corresponds to a normal position indication operation). In this case, the button operation determination unit 304 supplies the position indication data from the position indication data reception unit 303 to the coordinate conversion unit 305. The coordinate conversion unit 305 refers to the stored data of the screen memory area information storage unit 302 and converts the coordinate data (Xn, Yn) of the supplied position indication data into the coordinates of the memory area corresponding to the display mapped in the tablet apparatus 1 (step S104). The position indication data converted from the coordinate data is provided to the data providing unit 306. The data providing unit 306 supplies the position indication data from the coordinate conversion unit 305 to the tablet information processing unit 405 of the information processing apparatus 4 (step S105). In this way, the information processing apparatus 4 executes the process corresponding to the position indication data received from the tablet apparatus 1.

After the process of step S105, the control unit 401 of the information processing apparatus 4 functioning as the control unit of the tablet driver 3 determines whether there is a termination event of the process, such as turning off of the power (step S106). The process starting from step S102 is repeated if the control unit 401 determines that there is no termination event in the determination process of step S105. If the control unit 401 determines that there is a termination event in the determination process of step S105, the control unit 401 executes a series of termination processing (step S107) such as closing of the file in use, and ends the process illustrated in the flow chart of FIGS. 15 and 16.

On the other hand, assume that the button operation determination unit 304 determines in the determination process of step S103 that a pressing operation on the operation button 103 is involved (i.e., the position indication data corresponds to a gesture operation involving a pressing operation on the operation button 103). In this case, the button operation determination unit 304 supplies the position indication data from the position indication data reception unit 303 to the gesture determination unit 307. The gesture determination unit 307 determines the content of an instruction given by the gesture operation, on the basis of the change state in the position indication data sequentially supplied through the button operation determination unit 304 (step S108). In step S108, the gesture determination unit 307 determines whether the instruction is for switching the operation mode (FIGS. 6A to 6C) based on, for example, drawing of a circle with the electronic pen 2 while the operation button 103 is pressed, or is for switching the target display (FIGS. 2A to 5F) based on, for example, drawing of a straight line to the left, right, up, or down.

The gesture determination unit 307 determines whether the determination result of step S108 represents a switch of the operation mode (step S109). Assume that the gesture determination unit 307 determines in the determination process of step S109 that the instruction is not for switching the operation mode. In this case, the gesture determination unit 307 instructs the mapping switch processing unit 308 to change the field of “target screen” in the screen memory area information according to the determined gesture operation. As a result, the mapping switch processing unit 308 executes an updating process of the field of “target screen” of the screen memory area information storage unit 302 (step S110). In step S110, the mapping switch processing unit 308 executes a process of clearing the field of “target screen” of the immediately previous target display and setting the field of “target screen” of the next (current) target display indicated by the gesture operation to “ON(1).” Subsequently, the process proceeds to step S106.

Assume that the gesture determination unit 307 determines in the determination process of step S109 that the instruction is for switching the operation mode. In this case, the gesture determination unit 307 instructs the operation mode switch processing unit 309 to switch the operation mode. As a result, the operation mode switch processing unit 309 proceeds to the process of FIG. 16. The operation mode switch processing unit 309 refers to the information stored in the screen memory area information storage unit 302 to check the setting of the operation mode and determines whether the current operation mode is the individual mapping mode (step S111).

If the operation mode switch processing unit 309 determines in the determination process of step S111 that the current operation mode is the individual mapping mode, the operation mode switch processing unit 309 changes the setting of the operation mode of the screen memory area information storage unit 302 to the full mapping mode (step S112). Conversely, if the operation mode switch processing unit 309 determines in the determination process of step S111 that the current operation mode is not the individual mapping mode, the operation mode switch processing unit 309 changes the setting of the operation mode of the screen memory area information storage unit 302 to the individual mapping mode (step S113). After the process of step S112 and after the process of step S113, the process proceeds to step S106 of FIG. 15.

Note that, if the check flag of the screen memory area information stored in the screen memory area information storage unit 302 of the tablet driver 3 is “ON(1),” in step S108 the coordinate conversion unit (image formation unit) 305 functions to generate an initial display. The initial display is, for example, the display illustrated in FIGS. 5B and 6A. In step S110, the mapping switch processing unit 308 and the coordinate conversion unit (image formation unit) 305 function to display the progress illustrated in FIGS. 5C and 5D. In the process of steps S112 and S113, the operation mode switch processing unit 309 and the coordinate conversion unit (image formation unit) 305 function to display the result illustrated in FIG. 6B.

### Effects of Present Embodiment

In the information processing system of the present embodiment, the tablet driver 3 can function to switch the display (a memory area corresponding to the display) mapped in the tablet apparatus 1 based on a gesture operation on the tablet apparatus 1. In the information processing system of the embodiment, the tablet driver 3 can function to switch the operation mode based on a gesture operation on the tablet apparatus 1. Therefore, using only the tablet apparatus 1 as an input device, a user can readily use and control the multi-display function of the information processing apparatus 4 without cumbersome procedures.

### Modifications

Although the coordinate conversion unit 305 of the tablet driver 3 is described to also function as the image formation unit to simplify the description, the configuration is not limited to this example. The function of the image formation unit can be separated from the coordinate conversion unit 305 to be performed in an individual processing unit.

Although the operation button 103 of the tablet apparatus 1 is described as a button switch that can be pressed, the configuration is not limited to this example. The operation button 103 may be a touch sensor that can be touched (contacted) by a finger of the user or the like. A part of an operation button may be provided on a part of the operation surface 101S. That is, the operation button 103 is not limited to an element to be depressed. The operation button 103 may be a touch sensor or may be an operation section that can be brought up or down, such as a lever operation element. That is, the operation button 103 can be any one of various types of operation element that can be turned on and off.

When a predetermined operation button is provided on the electronic pen 2 and is pressed, status information may be transmitted from the electronic pen 2 to the tablet apparatus 1 to notify the tablet apparatus 1 of the pressing operation on the operation button. In this way, when the status information is transmitted from the electronic pen 2, the tablet apparatus 1 determines that the indication operation performed with the electronic pen 2 is a gesture operation. In this case, the tablet apparatus 1 outputs the coordinate data along with the predetermined status information. In this way, the normal position indication operation and the gesture operation can be distinguished from each other without providing a predetermined operation button on the tablet apparatus 1.

Although the electronic pen 2 is brought into contact with the operation surface 101S of the tablet apparatus 1 to perform a gesture operation in the description of the present embodiment, the configuration is not limited to this example. For example, when the tablet apparatus 1 is of an electromagnetic induction system, the trajectory of the electronic pen 2 can be detected by moving the electronic pen 2 in the air above the operation surface 101S, such as several centimeters above the operation surface 101S. In this way, the gesture operation with the electronic pen 2 may be performed in the air above the operation surface 101S of the tablet apparatus 1 as long as the movement trajectory of the electronic pen 2 can be detected.

Although the tablet apparatus 1 is a so-called plate tablet in the description of the present embodiment, the configuration is not limited to this example. The tablet apparatus 1 may be any tablet with a display function. Examples of such tablet with a display function include a so-called liquid crystal tablet which includes an LCD and a touch panel, and an organic electro-luminescence (EL) tablet which includes an organic electro-luminescence diode (OLED) display and a touch panel. Various other types of display elements can be combined with a touch panel to form a tablet with a display function.

In the case of using a tablet with a display function as the tablet apparatus, in response to activation of a predefined operation button for example, the display illustrated on the display 5(3) of FIG. 5B appears on a display screen of the tablet with a display function. The tablet with a display function can receive the necessary information from the screen memory information storage unit 302 of the tablet driver 3 to realize the display. Subsequently, when the electronic pen 2 is used to indicate a position on the intended display, the tablet with a display function provides the tablet driver 3 with the switch instruction information to switch to the intended display according to the indicated position. In this way, the display mapped to the tablet with a display function can be changed. The switch instruction information needs to include only information indicative of a display switch instruction and information indicative of the position of the intended display to be switched to.

Although a gesture operation for instructing the switch of the operation mode is described as an operation of drawing a circle in the above description, the configuration is not limited to this example. Various types of gesture operations can be used for this purpose as long as the gesture operation can be distinguished from a gesture operation for switching the display mapped to the tablet apparatus.

When the operation mode is switched from the individual mapping mode to the full mapping mode, there are several possible cases of an image displayed through the large display screen including a plurality of displays. In one case, the image displayed through the display, which is the target display in the most recent individual mapping mode as determined from the screen memory area information, can be displayed on the large display screen.

In another case, the image displayed through the display, which is most frequently used as the target display, can be displayed on the large display screen. In this case, the number of times that each display connected to the information processing apparatus 4 is used as the target display can be counted as one piece of information included in the screen memory area information, for example. In still another case, the image displayed through a predetermined display can be displayed on the large display screen. In this case, the user may be able to set the predetermined display. This information can be managed also by adding the information to the information stored in the screen memory area information storage unit 302 of the tablet driver 3.

Although one tablet apparatus 1 is connected to the information processing apparatus 4 to form the information processing system in the present embodiment, the configuration is not limited to this example. A plurality of tablet apparatuses can be connected to one information processing apparatus 4 to realize the multi-display function. In this case, the plurality of tablet apparatuses can be connected to the information processing apparatus 4 through one tablet driver, or the tablet apparatuses can be connected to the information processing apparatus 4 through different tablet drivers for the different tablet apparatuses.

In the former case, the multi-display function can be used in the same way on any tablet apparatus. In the latter case, the multi-display function can be used in the same way on any tablet apparatus if the screen memory area information is the same. By configuring different tablet drivers to use different screen memory area information, to thereby use different displays for different tablet apparatuses, it is possible to selectively use different displays for different tablet apparatuses. In this case, in the screen memory area information corresponding to the plurality of tablet apparatuses, it is necessary to disable use of the screen memory area information corresponding to any disabled display, for example by deleting such screen memory area information.

The display mapped in the tablet apparatus 1 among the plurality of displays 5(1), 5(2), 5(3), . . . connected to the information processing apparatus 4 through the tablet apparatus 1 has been described as one that can easily be switched in the description of the present embodiment. However, the configuration is not limited to this example. For example, the disclosure can also be applied when another information processing apparatus, such as a notebook PC, is used as an input apparatus. In this case, various types of pointing devices, such as a so-called mouse, a trackball mouse, and a joystick, connected to the input apparatus are used to perform the position indication operation and the gesture operation.

<Switching Target Display by Using Tablet with Display Function, without Using a Gesture>

When a tablet with a display function (such as a liquid crystal tablet or an organic EL tablet) is used as a tablet apparatus, a different method can be used to switch the target display, instead of switching the target display according to the embodiment described above. In the method as described above, the method of changing the association between the displays 5(1), 5(2), and 5(3) and the tablet apparatus 1 includes reading, by the sensor, a gesture of the electronic pen 2 to determine which display is to be associated with the tablet apparatus 1. Below, a case of changing the display (target display) mapped to the tablet apparatus without using the electronic pen 2 to perform a gesture operation will be described.

An information processing system of an example described below also includes a tablet apparatus 1X, the tablet driver 3, the information processing apparatus (PC) 4, and the displays 5(1) and 5(2) as with the information processing system described with reference to FIG. 1. However, the tablet apparatus 1X of this example is a tablet with a display function. In the case described in this example, to simplify the description, two displays 5(1) and 5(2) are connected to the information processing apparatus 4.

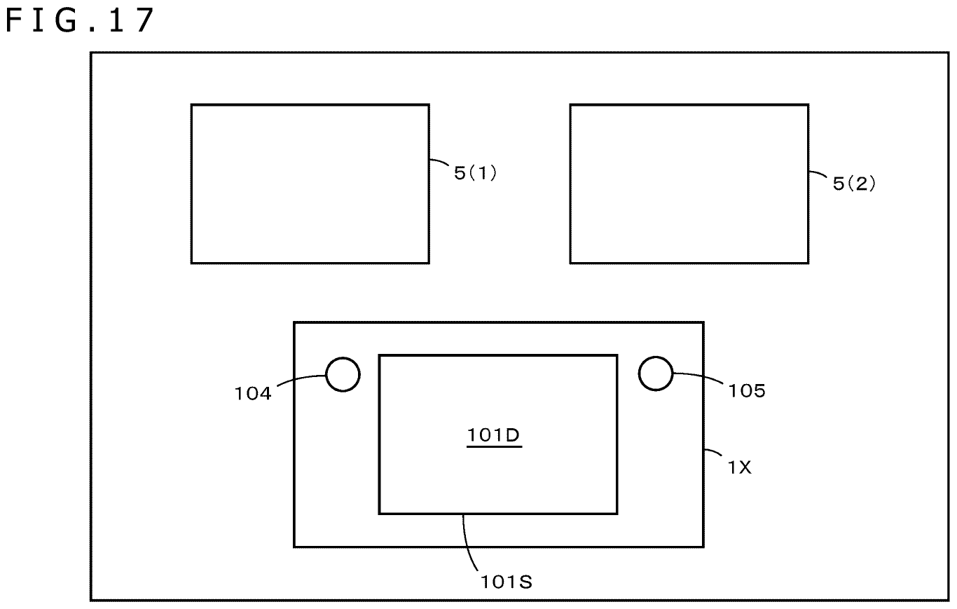

FIG. 17 is a diagram describing a case of switching the display (target display) mapped to the tablet 1X with a display function. As illustrated in FIG. 17, the tablet 1X with a display function includes the operation surface 101S corresponding to a display screen 101D of a display element, such as an LCD or OLED display. Therefore, the electronic pen 2 can be used to input an instruction or a drawing on the operation surface 101S, and the input result can be displayed on the display screen 101D.

As in the case of the information processing system described with reference to FIG. 1, the tablet 1X with a display function is connected to the information processing apparatus 4 through the tablet driver 3 and functions as an input device of the information processing apparatus 4. The tablet 1X with a display function can further select, as a target display, one of three displays including the display screen 101D of the tablet 1X with a display function, and the displays 5(1) and 5(2) connected to the information processing apparatus 4, as illustrated in FIG. 17.

In the state illustrated in FIG. 17, assume that different images are displayed on the display screen 101D of the tablet 1X with a display function, the display 5(1), and the display 5(2). For example, it is assumed that an image of a web page accessed through the information processing apparatus 4 is displayed on the display 5(1) and an image corresponding to photo software executed by the information processing apparatus 4 is displayed on the display 5(2). Assume also that an image corresponding to drawing software executed by the tablet 1X with a display function is displayed on the display screen 101D of the tablet 1X with a display function. That is, the target display corresponding to the operation area of the operation surface 101S of the tablet 1X with a display function is set to the display screen 101D of the tablet 1X with a display function.

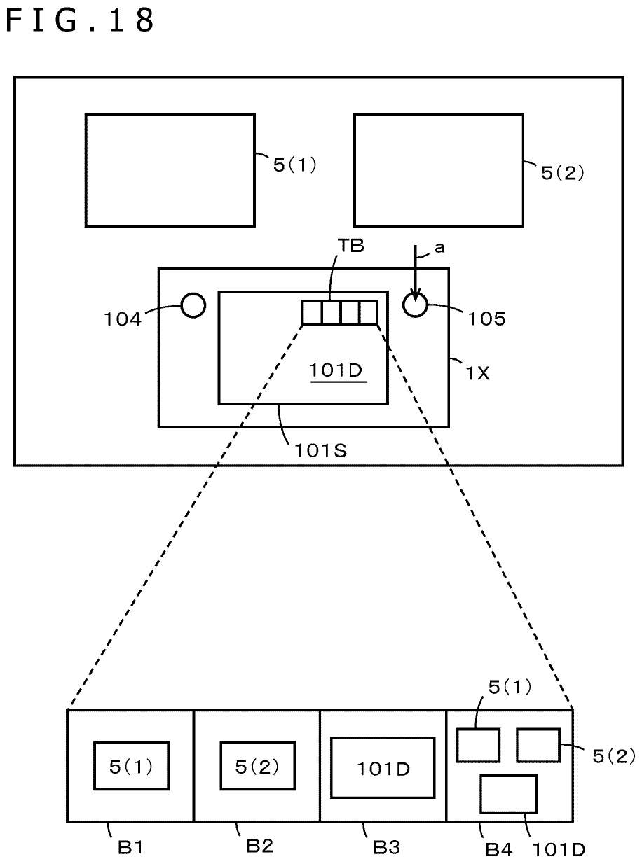

In this case, to change the target display corresponding to the operation area of the operation surface 101S of the tablet 1X with a display function, so-called toggle buttons TB (FIG. 18) are displayed on the display screen 101D, and an indication operation is performed on the toggle buttons TB. Specifically, either the operation button 104 provided on the upper left side or an operation button 105 provided on the upper right side of the tablet 1X with a display function of FIG. 17 is operated to display the toggle buttons TB on the display screen 101D to change the target display.

FIG. 18 is a diagram describing an example of an operation performed in the case of changing the display (target display) mapped to the tablet 1X with a display function. In FIG. 18, the operation button 105 provided on the upper right side of the tablet 1X with a display function is pressed as indicated by an arrow “a” to display the toggle buttons TB on the upper right side of the display screen 101D. The toggle buttons TB include selection buttons for the displays that can be the target display of the tablet 1X with a display function.

More specifically, four selection buttons B1, B2, B3, and B4 corresponding to the displays that can be selected as the target display are provided, as in an enlarged illustration of the toggle buttons TB on the lower side of FIG. 18. The selection button B1 is a button for selecting the display 5(1) as the target display. The selection button B2 is a button for selecting the display 5(2) as the target display. The selection button B3 is a button for selecting the display screen 101D of the tablet 1X with a display function as the target display. The selection button B4 is a button for selecting, as the target display, one large display formed of three displays including the display 5(1), the display 5(2), and the display screen 101D of the tablet 1X with a display function.

A user uses the electronic pen 2 to select the selection button corresponding to the intended display among the four selection buttons B1, B2, B3, and B4 of the toggle buttons TB displayed as in FIG. 18, to change (switch) the target display. For example, the user can select the selection button B1 to set the display 5(1) as the target display of the tablet 1X with a display function. In this way, the operation of the electronic pen 2 on the operation surface 101S of the tablet 1X with a display function is reflected on the display 5(1). Note that, in this case, the display on the display screen 101D of the tablet 1X with a display function is not affected. Therefore, the display image on the display screen 101D of the tablet 1X with a display function is the same as the display image on the display 5(1).

The user can select the selection button B2 to set the target display of the tablet 1X with a display function to the display 5(2). That is, the operation of the electronic pen 2 on the operation surface 101S of the tablet 1X with a display function is reflected on the display 5(2). Note that, in this case, the display on the display screen 101D of the tablet 1X with a display function is not affected. Therefore, the display image on the display screen 101D of the tablet 1X with a display function is the same as the display image on the display 5(2).

The user can select the selection button B3 to set the target display of the tablet 1X with a display function to the display screen 101D of the table 1X with a display function. That is, the operation of the electronic pen 2 on the operation surface 101S of the tablet 1X with a display function is reflected on the display screen 101D of the tablet 1X with a display function. Thus, this is the standard use mode because the target display of the tablet 1X with a display function is the display screen 101D of the tablet 1X itself, and the displays 5(1) and 5(2) can display images, such as images of a web page and a photo application, different from the image on the display screen 101D of the tablet 1X with a display function.

The user can select the selection button B4 to associate the operation surface 101S of the tablet 1X with a display function with all of the display 5(1), the display 5(2), and the display screen 101D. One large display including the three displays including the display 5(1), the display 5(2), and the display screen 101D of the tablet 1X with a display function can be the target display of the tablet 1X with a display function. In this way, the operation of the electronic pen 2 on the operation surface 101S of the tablet 1X with a display function is reflected on one large display including the three displays including the display 5(1), the display 5(2), and the display screen 101D of the tablet 1X with a display function.

In this way, the user can press the operation button 104 or the operation button 105 of the tablet 1X with a display function to display the toggle buttons TB and select one of the corresponding buttons B1 to B4 to be set, to instantaneously change (switch) the target display. That is, the tablet driver 3 can receive the position indication data from the tablet 1X with a display function to switch the target display.

Note that, in this example, the toggle buttons TB are displayed when the operation button 104 or the operation button 105 is operated on the tablet 1X with a display function. Subsequently, the tablet 1X with a display function can determine which one of the selection buttons B1, B2, B3, and B4 included in the displayed toggle buttons TB is operated. The tablet 1X with a display function can provide the instruction information for setting the selected display as the target display to the tablet driver 3 to switch the target display. In the modified configuration described with reference to FIGS. 17 and 18 also, the target display may be changed based on a gesture, as described above.

In FIG. 18, the selection button B1 is associated with the display 5(1), the selection button B2 is associated with the display 5(2), and the selection button B3 is associated with the display screen 101D of the tablet 1X with a display function. The selection button B4 is associated with one large screen including the display 5(1), the display 5(2), and the display screen 101D. In this case, indicia “left screen” is displayed in the display area of the selection button B1 of the toggle buttons TB, “right screen” is displayed in the display area of the selection button B2, “self screen (tablet screen)” is displayed in the display area of the selection button B3, and “all in one screen” is displayed in the display area of the selection button B4, to thereby allow the user to easily comprehend the meaning of each display.

Although the displays 5(1) and 5(2) and the display screen 101D are used as the displays that can be the target display in FIGS. 17 and 18, the configuration is not limited to this example. The number of selection buttons included in the toggle buttons TB can be set according to the number of displays that can be the target display.

### <Other Examples of Position Indicator>

In the embodiment described above, a target display is changed based on a gesture using the electronic pen 2 and, in the modifications described with reference to FIGS. 17 and 18, the electronic pen 2 is used to select the toggle buttons TB. However, the configuration is not limited to these examples. The target display can also be changed (switched) by a touch operation using a fingertip of the user when the tablet apparatus 1 or the tablet 1X with a display function includes a so-called touch sensor (a sensor that can detect the touch position of a fingertip of the operator).

### Others

As described in the embodiment above, it is possible to generate a program for executing the functions of the components of the tablet driver 3 illustrated in FIG. 9 and to configure the control unit 401 of the information processing apparatus 4 to be able to execute the program, to thereby realize a tablet driver program as software. In this case, the screen memory area information storage unit 302 can utilize hardware resources of the information processing apparatus 4, such as the non-volatile memory of the control unit 401 of the information processing apparatus 4 and the storage apparatus 402 of the information processing apparatus 4. The tablet driver 3 can also be software executed on the tablet apparatus 1.

It is also possible to configure a tablet driver apparatus, which includes hardware (a circuit unit) that executes the functions of the components of the tablet driver 3 as illustrated in FIG. 9, and to connect the tablet apparatus 1, via the tablet driver apparatus, to the information processing apparatus 4.

As described above, it is possible to generate a program for executing the functions of the components of the tablet driver 3 as illustrated in FIG. 9 and to configure the control unit 401 of the information processing apparatus 4 to be able to execute the program, to thereby realize a tablet driver program as software. That is, the tablet driver program is a program for executing the process as described with reference to the flow chart of FIGS. 15 and 16.

As described above, when the display to be mapped to the tablet apparatus 1 is determined, the memory area associated with the display is uniquely specified. Hence, when the display to be mapped to the tablet apparatus 1 is specified, the memory area to be mapped in the tablet apparatus 1 is specified. Therefore, switching the display mapped to (in) the tablet apparatus 1 is equivalent to switching the memory area mapped in the tablet apparatus 1.

1. A display switching system, comprising:
an information processing apparatus connected to a plurality of displays; and
an input apparatus configured to indicate a position on one of the plurality of displays to support use of the plurality of displays;
wherein the information processing apparatus includes:
an association unit configured to associate an input area of the input apparatus with a display area of one of the plurality of displays,
a determination unit configured to determine whether an input from the input apparatus is a position indication input or a change instruction input, and
a changing unit configured to change an association between the input apparatus and one of the plurality of displays based on the change instruction input;
wherein,
when the determination unit determines that the input from the input apparatus is the change instruction input, the changing unit changes the association between the input apparatus and one of the plurality of displays according to the change instruction input.

2. The display switching system according to claim 1, wherein
the input apparatus is a tablet apparatus, or a tablet apparatus having a display element, or another information processing apparatus and a pointing device.

3. The display switching system according to claim 1, wherein
the determination unit determines that the input from the input apparatus is the change instruction input when a defined operation section of the input apparatus is operated or when a defined action is performed on the input apparatus.

4. The display switching system according to claim 1, wherein
the determination unit determines that the input from the input apparatus is the change instruction input when an instruction section on the input apparatus is activated.

5. A display switching system, comprising:
a tablet apparatus; and
an information processing apparatus connected to displays;
wherein, when a defined operation section of the tablet apparatus is operated, the tablet apparatus sequentially outputs, at defined timings, instruction data capable of including: i) coordinate data, and ii) status information of the operation section; and
wherein the information processing apparatus includes:
an acquisition unit configured to acquire, based on attribute information of the displays, memory area information that associates memory areas, which correspond to the displays and which are reserved in a defined storage section of the information processing apparatus, with identification information of the displays;
a storage unit configured to store screen memory area information, which includes the memory area information acquired through the acquisition unit and specification information specifying a memory area mapped to the tablet apparatus;
a reception unit configured to receive the instruction data output from the tablet apparatus;
a gesture determination unit which, when the instruction data includes the coordinate data and the status information of the operation section, determines content of an instruction indicated by a gesture operation based on the coordinate data sequentially received through the reception unit; and
a switching process unit configured to refer to the screen memory area information stored in the storage unit and to change the specification information so as to specify a changed memory area based on the content of the instruction determined by the gesture determination unit.

6. The display switching system according to claim 5, which is operable in:
an individual mapping mode, in which individual processing is executed respectively through the displays connected to the information processing apparatus; and
a full mapping mode, in which processing is executed through one large display screen formed of the displays connected to the information processing apparatus;
wherein the screen memory area information stored in the storage unit includes mode information indicating a current mode; and
wherein the display switching system includes a mode switching process unit configured to refer to the screen memory area information stored in the storage unit and to change the mode information to specify a different mode when the content of the instruction determined by the gesture determination unit includes an instruction to switch the current mode.

7. The display switching system according to claim 5, further comprising:
a display processing unit which, when the content of the instruction determined by the gesture determination unit includes an instruction to change the memory area corresponding to one of the displays mapped to the tablet apparatus, refers to the screen memory area information stored in the storage unit and displays, based on the memory area mapped to the tablet apparatus, an indication of the changed memory area specified by the instruction to change the memory area.

8. The display switching system according to claim 6, further comprising:
a mode display processing unit which, when the content of the instruction determined by the gesture determination unit includes an instruction to switch the current mode, refers to the screen memory area information stored in the storage unit and displays, based on the memory area mapped to the tablet apparatus, the different mode specified by the changed mode information.

9. A tablet driver program comprising non-transitory computer-executable instructions which, when loaded to an information processing apparatus or a tablet apparatus, support use of displays connected to the information processing apparatus through the tablet apparatus,
wherein, when a defined operation section of the tablet apparatus is operated, the tablet apparatus sequentially outputs, at defined timings, instruction data capable of including: i) coordinate data; and ii) status information of the operation section;
the tablet driver program comprising:
an acquisition step of acquiring, based on attribute information of the displays, memory area information that associates memory areas, which correspond to the displays and which are reserved in a defined storage section of the information processing apparatus, with identification information of the displays;
a recording step of recording, in a storage unit, screen memory area information, which includes the memory area information acquired in the acquisition step and specification information specifying a memory area mapped in the tablet apparatus;
a reception step of receiving the instruction data output from the tablet apparatus;
a gesture determination step of, when the instruction data includes the coordinate data and the status information of the operation section, determining content of an instruction indicated by a gesture operation based on the coordinate data sequentially received in the reception step; and
a switching process step of referring to the screen memory area information stored in the storage unit and changing the specification information so as to specify a changed memory area based on the content of the instruction determined in the gesture determination step.

10. The tablet driver program according to claim 9, operable in:
an individual mapping mode, in which individual processing is executed respectively through the displays connected to the information processing apparatus; and
a full mapping mode, in which processing is executed through one large display screen formed of the displays connected to the information processing apparatus;
wherein the screen memory area information stored in the storage unit includes mode information indicating a current mode; and
wherein the tablet driver program further includes a switching process step of referring to the screen memory area information stored in the storage unit and changing the mode information to specify a different mode when the content of the instruction determined in the gesture determination step includes an instruction to switch the current mode.

11. The tablet driver program according to claim 9, further comprising:
a display process step of, when the content of the instruction determined in the gesture determination step includes an instruction to change the memory area corresponding to one of the displays mapped to the tablet apparatus, referring to the screen memory area information stored in the storage unit and displaying, based on the memory area mapped in the tablet apparatus, an indication of the changed memory area specified by the instruction to change the memory area.

12. The tablet driver program according to claim 10, further comprising:
a mode display processing step of, when the content of the instruction determined in the gesture determination step includes an instruction to switch the current mode, referring to the screen memory area information stored in the storage unit and displaying, based on the memory area mapped to the tablet apparatus, the different mode specified by the changed mode information.
